(19) United States
(12) Patent Application Publication
(10) Pub. No.: US 2008/0170566 A1
(43) Pub. Date: Jul. 17, 2008

(54) COMMUNICATION SYSTEM

(75) Inventor: Masao Akimoto, Fukuoka-shi (JP)

Correspondence Address: GREENBLUM & BERNSTEIN, P.L.C., 1950 ROLAND CLARKE PLACE, RESTON, VA, 20191, US

(73) Assignee: MATSUSHITA ELECTRIC INDUSTRIAL CO., LTD., Osaka (JP)

(21) Appl. No.: 11/971,423

(22) Filed: Jan. 9, 2008

(30) Foreign Application Priority Data
Jan. 11, 2007 (JP) 2007-003243

(51) Int. Cl. H04L 12/56

(52) U.S. Cl. 370/389

(57) ABSTRACT

A communication system, which includes an intercom master-station and an intercom door-station connected to a Regidential LAN, uses a DHCP protocol to assign IP addresses. The intercom master-station includes a setting management table, which sets connectivity per terminal name; a temporary address memory, which temporarily registers an IP address and MAC address of the intercom door-station, when APR-G is detected therefrom; and a management controller, which issues a terminal type request to the temporarily registered address and, when receiving a terminal type response to the terminal type request and determining that the intercom door-station is connectable to the intercom master-station, based on the connectivity associated with the terminal name in terminal type information, formally registers the temporarily registered address in a destination address memory. The intercom door-station registers an address of the intercom master-station in a remote-side destination address memory, when a registration request for connection from the intercom master-station is received.

### BACKGROUND OF THE INVENTION

1. Field of the Invention

The present invention relates to a communication system that includes a plurality of terminal apparatuses, such as, for example, a terminal having a monitor installed indoors and a terminal having a camera installed outdoors, such as at a door.

2. Description of Related Art

A conventionally known communication system is provided with an intercom master-station with a monitor (house information board and door phone) and an intercom door-station with a camera (lobby interphone apparatus), which are connected to an IP network. The intercom master-station and intercom door-station are assigned with IP addresses associated with unique call numbers.

Such a communication system is capable of establishing a door phone communication between the intercom master-station and intercom door-station, using IP addresses on the IP network.

In the communication system above, however, a huge workload is required for IP address assignment, since IP addresses are not automatically assigned to the intercom master-station and intercom door-station connected to the IP network.

In order to reduce the workload for IP address setting, a DHCP server may be used, which uses a DHCP protocol to automatically assign IP addresses to terminal apparatuses on the IP network, so as to automatically assign IP addresses through the DHCP server to terminal apparatuses, such as, for example, the intercom master-station, the intercom door-station, and the like. In this case, however, the DHCP server merely assigns the IP addresses. In order to establish a communication between the intercom master-station and intercom door-station, destination addresses need to be registered in the respective apparatuses, and the workload for destination address registration is substantially huge.

### SUMMARY OF THE INVENTION

The present invention is provided in view of the above-described problems. An object thereof is to provide a communication system that can substantially reduce the workload for destination address registration in terminal apparatuses, such as the intercom master-station and the intercom door-station, without requiring the workload related to IP address assignment.

To achieve the object above, a communication system according to the present invention has a first terminal apparatus and a second terminal apparatus connected to an IP network, a first IP address and a second IP address being assigned to the first terminal apparatus and the second terminal apparatus respectively by using a DHCP protocol, wherein the first terminal apparatus comprises; a information memory that stores information on the second terminal apparatus, the connectivity information indicating if the second terminal apparatus can connect with the first terminal apparatus; a buffer memory that stores the second IP address sent from the second terminal apparatus; a first destination address memory that stores a first destination address for the second terminal apparatus, a controller that sends a request to the second terminal apparatus by using the second IP address stored in the buffer memory to obtain a terminal information of the second terminal apparatus, determines if the second terminal apparatus can be connected with the first terminal apparatus according to the connectivity information stored in the connectivity information memory and the terminal information received from the second terminal apparatus, stores the second IP address in the buffer memory into the first destination address memory as the first destination address and sends a registration request to the second terminal apparatus, the registration request including the first IP address; wherein the second terminal apparatus comprises; a second destination address memory that stores a second destination address, the first IP address being stored in the second destination address as the second destination address when the second terminal apparatus receives the registration request from the first terminal apparatus.

In the communication system according to the present invention having the configuration above, a user of the terminal apparatus is able to register destination addresses in respective terminal apparatuses, with no workload related to IP address assignment, and thus the workload for registering the destination addresses is substantially reduced.

### BRIEF DESCRIPTION OF THE DRAWINGS

The present invention is further described in the detailed description which follows, with reference to the noted plurality of drawings by way of non-limiting examples of exemplary embodiments of the present invention, in which like reference numerals represent similar parts throughout the several views of the drawings, and wherein:

FIG. 1 illustrates a general system configuration of a door phone system according to an embodiment of the present invention;

FIG. 2 is a block diagram that illustrates a general configuration of an intercom master-station in the door phone system according to the present embodiment;

FIG. 3 is a block diagram that illustrates a general configuration of a router in the door phone system according to the present embodiment;

FIG. 4 is a block diagram that illustrates a general configuration of an intercom door-station in the door phone system according to the present embodiment;

FIG. 5 is a block diagram that illustrates a general configuration of a monitor camera in the door phone system according to the present embodiment;

FIG. 6 is a sequence diagram that briefly illustrates process operations of the router, intercom master-station, intercom door-station and monitor camera, relating to an automatic IP address assignment process according to the present embodiment;

FIG. 7 is a flowchart that illustrates process operations of the intercom master-station (intercom door-station and monitor camera), relating to an address conflict prevention process according to the present embodiment;

FIG. 8 is a sequence diagram that briefly illustrates process operations of the intercom master-station, intercom door-station and monitor camera, relating to an address registration process according to the present embodiment;

FIG. 9 is a flowchart that illustrates process operations of the intercom master-station, relating to a destination address registration process according to the present embodiment;

FIG. 10 is a flowchart that illustrates process operations of the intercom door-station, relating to a remote-side destination address registration process according to the present embodiment;

FIG. 11 is a flowchart that illustrates process operations of the monitor camera, relating to a camera-side destination address registration process according to the present embodiment;

FIG. 12 is a perspective view of the intercom master-station in the door phone system according to the embodiment of the present invention; and

FIG. 13 is a perspective view of the intercom door-station in the door phone system according to the embodiment of the present invention.

### DETAILED DESCRIPTION OF PREFERRED EMBODIMENTS

A first aspect of the present invention provides a communication system that has a plurality of terminal apparatuses connected to an IP network, and that, in response to an IP address assignment request, automatically assigns the IP address to each of the terminal apparatuses on the IP network using a DHCP protocol, wherein, of the plurality of terminal apparatuses, a specific terminal apparatus comprises: a controller that sets connectivity information on each terminal apparatus that shows if the terminal apparatus can be connected from the specific terminal apparatus, per terminal identification; a tentative address storage that keeps the IP address and MAC address of an additionally connected terminal apparatus contained in ARP-G, when ARP-G with the source IP address of the said additionally connected terminal apparatus is detected from the additionally connected terminal apparatus, which is additionally connected to the IP network; a terminal-type request notifier that notifies a terminal-type request toward the said additionally connected terminal apparatus, that contains the IP address and MAC address of the specific terminal apparatus, and that requests the said additionally connected terminal, to provide terminal-type information of the said additionally connected terminal apparatus; a terminal-type availability determinator that determines, after receiving a terminal-type response to the terminal-type request notice from the said additionally connected terminal apparatus, if the terminal identification information related to the terminal-type information of the additionally connected terminal apparatus, is contained in the terminal-type response or not; a connectivity determinator that determines, after the terminal-type availability determinator determines that the controller stores the terminal identification information related to the terminal-type information of the said additionally connected terminal apparatus, if the said additionally connected terminal apparatus is capable of connecting to the specific terminal apparatus, based on the connectivity information related to the terminal identification information; a destination address storage that formally registers the IP address and MAC address of the said additionally connected terminal apparatus, which is kept in the tentative address storage, as a destination address, after the connectivity determinator determines that the said additionally connected terminal apparatus is capable of connecting to the specific terminal apparatus; and a connection registration request notifier that notifies a registration request for the establish of the connection with the specific terminal apparatus, to the IP address and MAC address of the said additionally connected terminal apparatus, which is registered in the destination address storage; wherein the said additionally connected terminal apparatus comprises a destination address storage in itself that registers the IP address and MAC address related to the said specific terminal apparatus, which is contained in the registration request for the establish of the connection, as a destination address, after the additionally connected terminal apparatus receives the registration request for connection from the specific terminal apparatus.

Thus, in the communication system according to the first aspect of the present invention, the specific terminal apparatus has the controller that sets the connectivity information on each terminal apparatus that shows if the terminal apparatus can be connected from the specific terminal apparatus, per terminal identification information. When the DHCP protocol is used to automatically assign IP addresses to the plurality of terminal apparatuses on the IP network, the specific terminal apparatus detects ARP-G from the additionally connected terminal apparatus, which is additionally connected to the IP network, among the plurality of terminal apparatuses, and then temporarily registers the IP address and MAC address of the additionally connected terminal apparatus, which are included in the ARP-G. The specific terminal apparatus then notifies the terminal type request that includes the IP address and MAC address of the specific terminal apparatus, in order to request the additionally connected terminal apparatus having the temporarily registered IP address and MAC address, to provide the terminal type information of the additionally connected terminal apparatus. When receiving the terminal type response to the terminal type request notice from the additionally connected terminal apparatus, the specific terminal apparatus determines whether or not the controller stores the terminal identification information associated with the terminal type information of the additionally connected terminal apparatus, which is included in the terminal type response. When determining that the controller stores the terminal identification information associated with the terminal type information of the additionally connected terminal apparatus, the specific terminal apparatus determines whether or not the additionally connected terminal apparatus is capable of connecting to the specific terminal apparatus, based on the connectivity information associated with the terminal identification information. When determining that the additionally connected terminal apparatus is capable of connecting to the specific terminal apparatus, the specific terminal apparatus formally registers the temporarily registered IP address and MAC address of the additionally connected terminal apparatus, as the destination address. The specific terminal apparatus then notifies the registration request for connection to enable connection with the specific terminal apparatus, to the formally registered IP address and MAC address of the additionally connected terminal apparatus. When the additionally connected terminal apparatus receives the registration request for connection from the specific terminal apparatus, the additionally connected terminal apparatus registers the IP address and MAC address related to the specific terminal apparatus, which are included in the registration request for connection, as the destination address. Thereby, a user of the specific terminal apparatus and additionally connected terminal apparatus can register the destination addresses in the respective terminal apparatuses, based on the set information in the controller, with no workload related to IP address assignment, and thus the workload for registering the destination addresses is substantially reduced.

A second aspect of the present invention provides the communication system wherein, in addition to the configuration of the first aspect, the additionally connected terminal apparatus comprises: a broadcast transmitter that broadcasts ARP-G with the source IP address of the said additionally connected terminal apparatus, when the IP address is automatically assigned via the DHCP protocol to the said additionally connected terminal apparatus; an ARP-G response detector that sees, after the broadcast transmitter broadcasts ARP-G, whether or not a response is detected in response to the ARP-G within a predetermined time; and a source address storage that stores the IP address, which is automatically assigned associated with a MAC address of the additionally connected terminal apparatus, as a source address, if the ARP-G response detector sees no response to the ARP-G, and that discards the automatically assigned IP address, if the ARP-G response detector sees a response to the ARP-G.

Thus, in the communication system according to the second aspect of the present invention, in addition to the effects of the first aspect, when the additionally connected terminal apparatus is automatically assigned with an IP address through the DHCP protocol in order to additionally connect to the IP network, the additionally connected terminal apparatus performs broadcast ARP-G having the IP address as the target address. When detecting no response to the ARP-G within the predetermined time, the additionally connected terminal apparatus stores the IP address, which is automatically assigned associated with the MAC address of the additionally connected terminal apparatus, as the source address. When detecting a response to the ARP-G, the additionally connected terminal apparatus discards the automatically assigned IP address. Thereby, even when the additionally connected terminal apparatus is automatically assigned with an IP address through the DHCP protocol in order to additionally connect to the IP network, an IP address conflict can be avoided on the IP network.

A third aspect of the present invention provides the communication system wherein, in addition to the configuration of the first or second aspect, the specific terminal apparatus comprises: a promiscuous mode activator activates the promiscuous mode after the specific terminal apparatus detects ARP-G from the additionally connected terminal apparatus, monitor unicast communications between other terminal apparatuses, wherein when detecting a response to the ARP-G from the additionally connected terminal apparatus during the promiscuous mode, the specific terminal apparatus discards the IP address and MAC address of the additionally connected terminal apparatus, which is kept in the tentative address storage.

Thus, in the communication system according to the third aspect of the present invention, in addition to the effects of the first or second aspect, the specific terminal apparatus enters the promiscuous mode, in which the specific terminal apparatus monitors unicast communications among the other terminal apparatuses, when detecting ARP-G from the additionally connected terminal apparatus. When detecting a response to the ARP-G from the additionally connected terminal apparatus in the promiscuous mode, the specific terminal apparatus discards the IP address and MAC address of the additionally connected terminal apparatus, which are tentatively kept in the tentative address storage. Thereby, when detecting the response to the ARP-G from the additionally connected terminal apparatus, the specific terminal apparatus determines that the IP address of the additionally connected terminal apparatus conflicts, and thus discards the tentatively kept IP address and MAC address of the additionally connected terminal apparatus.

A fourth aspect of the present invention provides the communication system wherein, in addition to the configuration of the first, second, or third aspect, the specific terminal apparatus uses one of the destination IP address and MAC address, which is stored in the destination address storage, to establish the connection with the destination terminal apparatus; and the additionally connected terminal apparatus uses one of the destination IP address and MAC address, which is stored in the destination address storage to establish the connection with the destination terminal apparatus.

Thus, in the communication system according to the fourth aspect of the present invention, in addition to the effects of the first, second, or third aspect, the specific terminal apparatus uses the destination IP address or MAC address, which is stored in the destination address storage, so as to connect and communicate with the destination terminal apparatus; and the additionally connected terminal apparatus uses the destination IP address or MAC address, which is stored in the destination address storage thereof, to establish the connection with the destination terminal apparatus. Thereby, address input operation is not required to secure a communication between the specific terminal apparatus and additionally connected terminal apparatus.

A fifth aspect of the present invention provides the communication system wherein, in addition to the configuration of the first, second, third, or fourth aspect, the terminal identification information includes a terminal name that identifies the terminal apparatus, and a terminal type associated with the terminal type information of the terminal apparatus.

Thus, in the communication system according to the fifth aspect of the present invention, in addition to the effects of the first, second, third, or fourth aspect, the terminal identification information includes the terminal name that identifies the terminal apparatus, and the terminal type associated with the terminal type information of the terminal apparatus. Thereby, the specific terminal apparatus can determine whether or not the terminal identification information is in the controller, based on the terminal name or terminal type, which is associated with the terminal type information included in the terminal type response from the additionally connected terminal apparatus.

A sixth aspect of the present invention provides a communication system that has at least one intercom master-station and one intercom door-station, which are connected to an IP network, and that, in response to an IP address assignment request, automatically assigns an IP address to each intercom master-station one and intercom door-station on the IP network using a DHCP protocol, wherein the intercom master-station comprises: a controller that sets connectivity information on each intercom door-station that shows if the intercom door-station can be connected from the intercom master-station; a tentative address storage that keeps the IP address and MAC address of the intercom door-station contained in ARP-G, when ARP-G with the source IP address of the said additionally connected intercom door-station is detected from the intercom door-station, which is additionally connected to the IP network; a terminal-type request notifier that notifies a terminal-type toward the said additionally connected intercom door-station that contains the IP address and MAC address of the intercom master-station, and that requests the said intercom door-station to provide terminal-type information of the said additionally connected intercom door-station; a terminal-type availability determinator that determines, after receiving a terminal-type response to the terminal-type request notice from the said intercom door-station, whether or not the controller stores the terminal identification information associated with the terminal-type information of the connected intercom door-station, which is included in the terminal-type response; a connectivity determinator that determines, after the terminal-type availability determinator determines that the controller stores the terminal identification information associated with the terminal-type information of the intercom door-station, whether or not the intercom door-station is ready to the intercom master-station, based on the connectivity information associated with the terminal identification information; a destination address storage that formally registers the IP address and MAC address of the intercom door-station, which is kept in the temporary address storage, as a destination address, after the connectivity determinator determines that the intercom door-station is capable of connecting to the intercom master-station; and a connection registration request notifier that notifies a registration request for the establishment of the connection to enable connection with the intercom master-station, to the IP address and MAC address of the intercom door-station, which is registered in the destination address storage; wherein the intercom door-station comprises a remote-side destination address storage that registers the IP address and MAC address related to the intercom master-station, which is contained in the registration request for the establish of the connection, as a destination address, after the intercom door-station receives the registration request for connection from the intercom master-station.

Thus, in the communication system according to the sixth aspect of the present invention, the intercom master-station has the controller that sets the connectivity information on each intercom door-station that shows if the intercom door-station can be connected from the intercom master-station, per terminal identification information that identifies the intercom door-station. When the DHCP protocol is used to automatically assign IP addresses to the intercom master-station and intercom door-stations on the IP network, the intercom master-station detects ARP-G from the intercom door-station, which is additionally connected to the IP network, and then tentatively keeps the IP address and MAC address of the intercom door-station, which are included in the ARP-G. The intercom master-station then notifies the terminal type request that includes the IP address and MAC address of the intercom master-station, in order to request the intercom door-station having the temporarily registered IP address and MAC address, to provide the terminal type information of the intercom door-station. When receiving the terminal type response to the terminal type request notice from the intercom door-station, the intercom master-station determines whether or not the controller stores the terminal identification information associated with the terminal type information of the intercom door-station, which is included in the terminal type response. When determining that the controller stores the terminal identification information associated with the terminal type information of the intercom door-station, the intercom master-station determines whether or not the intercom door-station is capable of connecting to the intercom master-station, based on the connectivity information associated with the terminal identification information. When determining that the intercom door-station is capable of connecting to the intercom master-station, the intercom master-station formally registers the tentatively kept IP address and MAC address of the intercom door-station, as the destination address. The intercom master-station then notifies the registration request for connection to enable connection with the intercom master-station, to the formally registered IP address and MAC address of the intercom door-station. When the door terminal apparatus receives the registration request for connection from the intercom master-station, the intercom door-station registers the IP address and MAC address related to the intercom master-station, which are included in the registration request for connection, as the destination address. Thereby, a user of the intercom master-station and intercom door-station can register the destination addresses in the respective apparatuses, with no workload related to IP address assignment, and thus the workload for registering the destination addresses is substantially reduced.

A seventh aspect of the present invention provides a communication system that has a plurality of intercom master-station and a plurality of intercom door-station, which are connected to an IP network, and that, in response to an IP address assignment request, automatically assigns an IP address to each intercom master-station one and intercom door-station on the IP network using a DHCP protocol, wherein intercom master-station comprises: a controller that sets connectivity information on each intercom door-station that shows if the intercom door-station can be connected from the intercom master-station; a tentative address storage that keeps the IP address and MAC address of the intercom door-station contained in ARP-G, when ARP-G with the source IP address of the said additionally connected intercom door-station is detected from the intercom door-station, which is additionally connected to the IP network; a terminal-type request notifier that notifies a terminal-type toward the said additionally connected intercom door-station that contains the IP address and MAC address of the intercom master-station, and that requests the said intercom door-station to provide terminal-type information of the said additionally connected intercom door-station; a terminal-type availability determinator that determines, after receiving a terminal-type response to the terminal-type request notice from the said intercom door-station, whether or not the controller stores the terminal identification information associated with the terminal-type information of the connected intercom door-station, which is included in the terminal-type response; a connectivity determinator that determines, after the terminal-type availability determinator determines that the controller stores the terminal identification information associated with the terminal-type information of the connected intercom door-station, whether or not the connected intercom door-station is capable of connecting to the intercom master-station, based on the connectivity information associated with the terminal identification information; a destination address storage that finally registers the IP address and MAC address of the intercom master-station, which are kept in the tentative address storage, as a destination address, when the connectivity determinator determines that the connected intercom door-station is capable of connecting to the intercom master-station; and a connection registration request notifier notifies a registration request for connection to enable connection with the intercom master-station, to the IP address and MAC address of the connected intercom door-station, which are formally registered in the destination address storage; wherein the connected intercom door-station has a remote-side destination address storage that registers the IP address and MAC address related to the intercom master-station, which are included in the registration request for connection, as a destination address, when the connected intercom door-station receives the registration request for connection from the intercom master-station.

Thus, in the communication system according to the seventh aspect of the present invention, each of the plurality of intercom master-stations has the controller that sets the connectivity information on each intercom door-station that if the each intercom door-station can be connected from the intercom master-station. When the DHCP protocol is used to automatically assign IP addresses to the intercom master-station and the intercom door-station on the IP network, the intercom master-station detects ARP-G from the intercom door-station, which is additionally connected to the IP network, and then tentatively keeps the IP address and MAC address of the intercom door-station, which are included in the ARP-G. The intercom door-station then notifies the terminal type request that includes the IP address and MAC address of the intercom door-station, in order to request the intercom door-station having the tentatively kept IP address and MAC address, to provide the terminal type information of the intercom door-station. When receiving the terminal type response to the terminal type request from the intercom door-station, the intercom master-station determines whether or not the controller stores the terminal identification information associated with the terminal type information of the intercom door-station, which is included in the terminal type response. When determining that the controller stores the terminal identification information associated with the terminal type information of the intercom door-station, the intercom master-station determines whether or not the intercom door-station is capable of connecting to the intercom master-station, based on the connectivity information associated with the terminal identification information. When determining that the intercom door-station is capable of connecting to the intercom master-station, the intercom master-station formally registers the tentatively kept IP address and MAC address of the intercom door-station, as the destination address. The intercom master-station then notifies the registration request for connection to enable connection with the intercom master-station, to the formally registered IP address and MAC address of the intercom door-station. When the intercom door-station receives the registration request for connection from the intercom master-station, the intercom door-station registers the IP address and MAC address related to the intercom master-station, which are included in the registration request for connection, as the destination address. Thereby, even with the communication system for a plurality of households that includes the plurality of intercom master-stations and the plurality of intercom door-stations, a user of the intercom master-station and the intercom door-station can register the destination addresses in the respective stations, with no workload related to IP address assignment, and thus the workload for registering the destination addresses is substantially reduced.

An eighth aspect of the present invention provides the communication system wherein, in addition to the configuration of the six or seventh aspect, the connected intercom door-station comprises: a broadcast transmitter that broadcasts ARP-G with the source IP address of the said additionally connected intercom door-station, when an IP address is automatically assigned via the DHCP protocol to the said additionally connected intercom door-station; an ARP-G response detector that sees, after the broadcast transmitter broadcasts ARP-G, whether or not a response is detected in response to the ARP-G within a predetermined time; and a source address storage that stores the IP address, which is automatically assigned associated with a MAC address of the intercom door-station, as a source address, if the ARP-G response detector sees no response to the ARP-G, and that discards the automatically assigned IP address, when the ARP-G response detector detects a response to the ARP-G.

Thus, in the communication system according to the eighth aspect of the present invention, in addition to the effects of the sixth or seventh aspect, when the intercom door-station is automatically assigned with an IP address through the DHCP protocol in order to additionally connect to the IP network, the intercom door-station performs broadcast ARP-G having the IP address as the target address. When detecting no response to the ARP-G within the predetermined time, the intercom door-station stores the IP address, which is automatically assigned associated with the MAC address of the intercom door-station, as the source address. When detecting a response to the ARP-G, the intercom door-station discards the automatically assigned IP address. Thereby, even when the intercom door-station is automatically assigned with an IP address through the DHCP protocol in order to additionally connect to the IP network, an IP address conflict can be avoided on the IP network.

A ninth aspect of the present invention provides the communication system wherein, in addition to the configuration of the sixth, seventh, or eighth aspect, the intercom master-station comprises: a promiscuous mode activator activates the promiscuous mode after the intercom master-station detects ARP-G from the connected intercom door-stations, the promiscuous mode allowing monitoring of unicast communication between other terminal apparatuses, wherein when detecting a response to the ARP-G from the intercom door-station in the promiscuous mode, the intercom master-station discards the IP address and MAC address of the connected intercom door-stations, which is kept in the tentative address storage.

Thus, in the communication system according to the ninth aspect of the present invention, in addition to the effects of the sixth, seventh, or eighth aspect, the intercom master-station enters the promiscuous mode, in which the intercom master-station monitors unicast communications among the intercom door-stations, when detecting ARP-G from the intercom door-station. When detecting a response to the ARP-G from the intercom door-station in the promiscuous mode, the intercom master-station discards the IP address and MAC address of the intercom door-station, which are tentatively kept in the tentative address storage. Thereby, when detecting the response to the ARP-G from the intercom door-station, the intercom master-station determines that the IP address of the intercom door-station conflicts, and thus discards the tentatively kept IP address and MAC address of the intercom door-station.

A tenth aspect of the present invention provides the communication system wherein, in addition to the configuration of the sixth, seventh, eighth, or ninth aspect, the intercom master-station uses one of the destination IP address and MAC address, which is stored in the destination address storage, to establish the connection with the destination intercom door-station; and the connected intercom door-station uses one of the destination IP address and MAC address, which is stored in the remote-side destination address storage to establish the connection with the destination intercom master-station.

Thus, in the communication system according to the tenth aspect of the present invention, in addition to the effects of the sixth, seventh, eighth, or ninth aspect, the intercom master-station uses the destination IP address or MAC address, which is stored in the destination address storage, so as to connect and communicate with the destination terminal apparatus; the intercom door-station uses the destination IP address or MAC address, which is stored in the remote-side destination address storage, to establish the connection with the destination terminal apparatus. Thereby, address input operation is not required to secure a communication between the intercom master-station and the intercom door-station.

An eleventh aspect of the present invention provides the communication system wherein, in addition to the configuration of the sixth, seventh, eighth, ninth, or tenth aspect, the terminal identification information includes a terminal name that identifies the intercom door-station, and a terminal type associated with the terminal-type information of the connected intercom door-station.

Thus, in the communication system according to the eleventh aspect of the present invention, in addition to the effects of the sixth, seventh, eighth, ninth, or tenth aspect, the terminal identification information includes the terminal name that identifies the intercom door-station, and the terminal type associated with the terminal type information of the intercom door-station. Thereby, the intercom master-station can determine whether or not the terminal identification information is in the controller, based on the terminal name or terminal type, which is associated with the terminal type information included in the terminal type response from the intercom door-station.

A twelfth aspect of the present invention provides a communication system that has at least one master-monitor-station and one intercom door-station and one monitor camera, which are connected to an IP network, and that, in response to an IP address assignment request, automatically assigns an IP address to each intercom master-monitor-station and one intercom door-station and one monitor camera on the IP network using a DHCP protocol, wherein the master-monitor-station comprises: a controller that sets connectivity information on each intercom door-station and each monitor camera that shows if the intercom door-station and the monitor camera can be connected from the master-monitor-station; a tentative address storage that keeps the an IP address and MAC address of one of the intercom door-station and monitor camera contained in ARP-G, when ARP-G with the source IP address of the said additionally connected intercom door-station is detected from one of the intercom door-station and monitor camera, which is additionally connected to the IP network; a terminal-type request notifier that notifies a terminal-type toward the said additionally connected intercom door-station and monitor camera that contains the IP address and MAC address of the intercom master-station, and that requests one of the intercom door-station and monitor camera, to provide terminal-type information of one of the intercom door-station and monitor camera; a terminal-type availability determinator that determines, after receiving a terminal-type response to the terminal-type request notice from one of the said intercom door-station and monitor camera, whether or not the controller stores the terminal identification information associated with the terminal-type information of one of the connected intercom door-station and monitor camera, which is included in the terminal-type response; a connectivity determinator that determines, after the terminal-type availability determinator determines that the controller stores the terminal identification information associated with the terminal-type information of one of the intercom door-station and monitor camera is capable of connecting to the master-monitor-station, based on the connectivity information associated with the terminal identification information; a destination address storage that formally registers the IP address and MAC address of one of the intercom door-station and monitor camera, which are kept in the tentative address storage, as a destination address, when the connectivity determinator determines that one of the intercom door-station and monitor camera is capable of connecting to the master-monitor-station; and a connection registration request notifier that notifies a registration request for connection to enable connection with the master-monitor-station, to the IP address and MAC address of connected intercom door-station and monitor camera, which are formally registered in the destination address storage; wherein the intercom door-station has a remote-side destination address storage that registers the IP address and MAC address related to master-monitor-station, which are included in the registration request for connection, as a destination address, when the intercom door-station receives the registration request for connection from master-monitor-station; and the monitor camera has a camera-side destination address storage that registers the IP address and MAC address related to the master-monitor-station, which are included in the registration request for connection, as a destination address, when the monitor camera receives the registration request for connection from the master-monitor-station.

Thus, in the communication system according to the twelfth aspect of the present invention, the master-monitor-station has the controller that sets the connectivity information on each intercom door-station and each monitor camera that shows if the intercom door-station and the monitor camera can be connected from the master-monitor-station. When the DHCP protocol is used to automatically assign IP addresses to the master-monitor-station, intercom door-station, and monitor camera on the IP network, the master-monitor-station detects ARP-G from the intercom door-station or monitor camera, which is additionally connected to the IP network, and then tentatively keeps the IP address and MAC address of the intercom door-station or monitor camera, which are included in the ARP-G. The master-monitor-station then notifies the terminal type request that includes the IP address and MAC address of the master-monitor-station, in order to request the intercom door-station or monitor camera having the tentatively kept IP address and MAC address, to provide the terminal type information of the intercom door-station or monitor camera. When receiving the terminal type response to the terminal type request notice from the intercom door-station or monitor camera, the master-monitor-station determines whether or not the controller stores the terminal identification information associated with the terminal type information of the intercom door-station or monitor camera, which is included in the terminal type response. When determining that the controller stores the terminal identification information associated with the terminal type information of the intercom door-station or monitor camera, the master-monitor-station determines whether or not the intercom door-station or monitor camera is capable of connecting to the master-monitor-station, based on the connectivity information associated with the terminal identification information. When determining that the intercom door-station or monitor camera is capable of connecting to the master-monitor-station, the master-monitor-station formally registers the tentatively kept IP address and MAC address of the intercom door-station or monitor camera, as the destination address. The master-monitor-station then notifies the registration request for connection to enable connection with the master-monitor-station, to the formally registered IP address and MAC address of the intercom door-station or monitor camera. When the intercom door-station receives the registration request for connection from the master-monitor-station, the intercom door-station registers the IP address and MAC address related to the master-monitor-station, which are included in the registration request for connection, as the destination address. When the monitor camera receives the registration request for connection from the master-monitor-station, the monitor camera registers the IP address and MAC address related to the master-monitor-station, which are included in the registration request for connection, as the destination address. Thereby, a user of the master-monitor-station, intercom door-station, and monitor camera can register the destination addresses in the respective stations with no workload related to IP address assignment, and thus the workload for registering the destination addresses is substantially reduced.

A thirteenth aspect of the present invention provides the communication system wherein, in addition to the configuration of the twelfth aspect, intercom door-station comprises: a remote-side broadcast transmitter that broadcasts ARP-G with the source IP address of the connected intercom door-station, when the IP address is automatically assigned via the DHCP protocol to the said additionally intercom door-station; a remote-side ARP-G response detector that sees, after the remote-side broadcast transmitter broadcasts ARP-G, whether or not a response is detected in response to the ARP-G within a predetermined time; and a remote-side source address storage that stores the IP address, which is automatically assigned associated with a MAC address of the connected intercom door-station, as a source address, if the remote-side ARP-G response detector sees no response to the ARP-G, and that discards the automatically assigned IP address, if the remote-side ARP-G response detector sees a response to the ARP-G; and wherein the monitor camera comprises: a camera-side broadcast transmitter broadcasts ARP-G with the source IP address of the said additionally connected monitor camera, when the IP address is automatically assigned via the DHCP protocol to the said additionally connected monitor camera; a camera-side ARP-G response detector that sees, after the camera-side broadcast transmitter broadcasts ARP-G, whether or not a response is detected in response to the ARP-G within a predetermined time; and a camera-side source address storage that stores the IP address, which is automatically assigned associated with a MAC address of the monitor camera, as a source address, if the camera-side ARP-G response detector sees no response to the ARP-G, and that discards the automatically assigned IP address, when the camera-side ARP-G response detector detects a response to the ARP-G.

Thus, in the communication system according to the thirteenth aspect of the present invention, in addition to the effects of the twelfth aspect, when the intercom door-station is automatically assigned with an IP address through the DHCP protocol in order to additionally connect to the IP network, the intercom door-station performs broadcast ARP-G having the IP address as the target address. When detecting no response to the ARP-G within the predetermined time, the intercom door-station keeps the IP address, which is automatically assigned associated with the MAC address of the intercom door-station, as the source address. When detecting a response to the ARP-G, the intercom door-station discards the automatically assigned IP address. Further, when the monitor camera is automatically assigned with an IP address through the DHCP protocol in order to additionally connect to the IP network, the monitor camera performs broadcast transmission of ARP-G having the IP address as the target address. When detecting no response to the ARP-G within the predetermined time, the monitor camera stores the IP address, which is automatically assigned associated with the MAC address of the monitor camera, as the source address. When detecting a response to the ARP-G, the monitor camera discards the automatically assigned IP address. Thereby, even when the intercom door-station and monitor camera are automatically assigned with IP addresses through the DHCP protocol in order to additionally connect to the IP network, an IP address conflict can be avoided on the IP network.

A fourteenth aspect of the present invention provides the communication system wherein, in addition to the configuration of the twelfth or thirteenth aspect, the master-monitor-station comprises: a promiscuous mode activator activates the promiscuous mode, after the master-monitor-station detects ARP-G from one of the intercom door-station and monitor camera, the promiscuous mode allowing monitoring of unicast communications between other terminal apparatuses, wherein when detecting a response to the ARP-G from one of the intercom door-station and monitor camera in the promiscuous mode, the indoor monitor apparatus discards the IP address and MAC address of one of the intercom door-station and monitor camera, which are kept in the tentative address storage.

Thus, in the communication system according to the fourteenth aspect of the present invention, in addition to the effects of the twelfth or thirteenth aspect, the master-monitor-apparatus enters the promiscuous mode, in which the master-monitor-apparatus monitors unicast communications among the other terminal apparatuses, when detecting ARP-G from the intercom door-station. When detecting a response to the ARP-G from the intercom door-station or monitor camera in the promiscuous mode, the master-monitor-apparatus discards the IP address and MAC address of the intercom door-station or monitor camera, which are tentatively kept in the tentative address storage. Thereby, when detecting the response to the ARP-G from the intercom door-station or monitor camera, the master-monitor-apparatus determines that the IP address of the intercom door-station or monitor camera conflicts, and thus discards the tentatively kept IP address and MAC address of the intercom door-station or monitor camera.

A fifteenth aspect of the present invention provides the communication system wherein, in addition to the configuration of the twelfth, thirteenth, or fourteenth aspect, the master-monitor-station uses one of the destination IP address and MAC address, which is stored in the destination address storage, to establish the connection with one of the destination intercom door-station and monitor camera; the intercom door-station uses one of the destination IP address and MAC address, which is stored in the remote-side destination address storage, to establish the connection with the destination master-monitor-station; and the monitor camera uses one of the destination IP address and MAC address, which is stored in the camera-side destination address storage, so as to establish the connection with the destination master-monitor-station.

Thus, in the communication system according to the fifteenth aspect of the present invention, in addition to the effects of the twelfth, thirteenth, or fourteenth aspect, the master-monitor-station uses the destination IP address or MAC address, which is stored in the destination address storage, to establish the communication with the intercom door-station and the monitor camera; the intercom door-station uses the destination IP address or MAC address, which is stored in the remote-side destination address storage, to establish the communication with the destination master-monitor-station; the monitor camera uses the destination IP address or MAC address, which is stored in the camera-side destination address storage, to establish the communication with the destination master-monitor-station. Thereby, address input operation is not required on the master-monitor-station to receive a call and image from the intercom door-station as well as to receive an image from the monitor camera.

A sixteenth aspect of the present invention provides the communication system wherein, in addition to the configuration of the twelfth, thirteenth, fourteenth, or fifteenth aspect, the terminal identification information includes a terminal name that identifies the door camera apparatus or monitor camera, and a terminal type associated with the terminal type information of the door camera apparatus or monitor camera.

Thus, in the communication system according to the sixteenth aspect of the present invention, in addition to the effects of the twelfth, thirteenth, fourteenth, or fifteenth aspect, the terminal identification information includes a terminal name that identifies one of the intercom door-station and monitor camera, and a terminal type associated with the terminal type information of one of the intercom door-station and monitor camera.

A seventeenth aspect of the present invention provides the communication system wherein, in addition to the configuration of the twelfth, thirteenth, fourteenth, fifteenth, or sixteenth aspect, the master-monitor-station has a display that identifies and displays the connectivity information per terminal identification information set in the controller.

Thus, in the communication system according to the seventeenth aspect of the present invention, in addition to the effects of the twelfth, thirteenth, fourteenth, fifteenth, or sixteenth aspect, the master-monitor-station has the display that identifies and displays the connectivity information per terminal identification information set in the controller. Thereby, a user of the master-monitor-station can recognize the connectivity information per terminal identification information, based on the information displayed on the display.

### EMBODIMENT

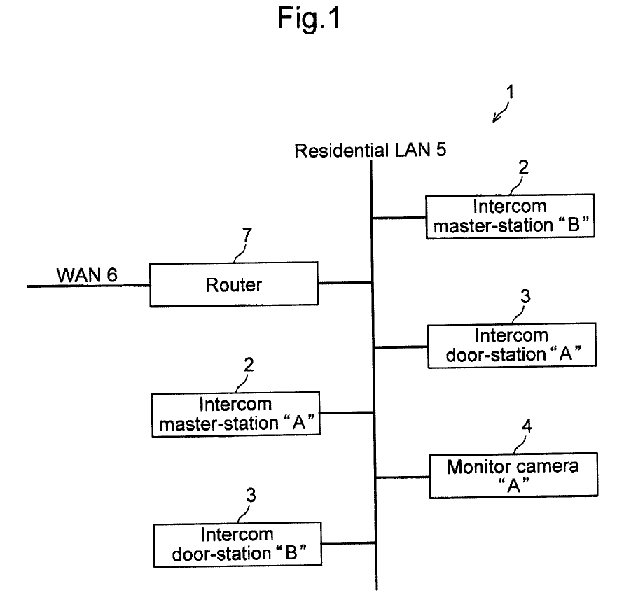

A door phone system is explained in the following, as an embodiment of the present invention with reference to the above-described drawings. FIG. 1 illustrates a general system configuration of the door phone system according to the present embodiment.

Door phone system 1 shown in FIG. 1 corresponds to, for example, a door phone system for a duplex. Door phone system 1 includes intercom master-stations 2, which are placed in each household; intercom door-stations 3, which are placed at a door of each household; one monitor camera 4, which is placed near a predetermined location of either of the households; Regidential LAN 5, which connects two intercom master-stations 2, two intercom door-stations 3, and one monitor camera 4; and router 7, which connects Regidential LAN 5 and WAN 6. Router 7 uses a DHCP server function to automatically assign IP addresses to intercom master-stations 2, intercom door-stations 3, and monitor camera 4. For instance, door phone system 1 uses one intercom master-station 2 and one intercom door-station 3 in each household of the duplex. A visitor calls from intercom door-station 3 at the door, and a person in the household can talk to the visitor while watching a camera image on corresponding intercom master-station 2. In addition, persons can talk between the households using two intercom master-stations 2.

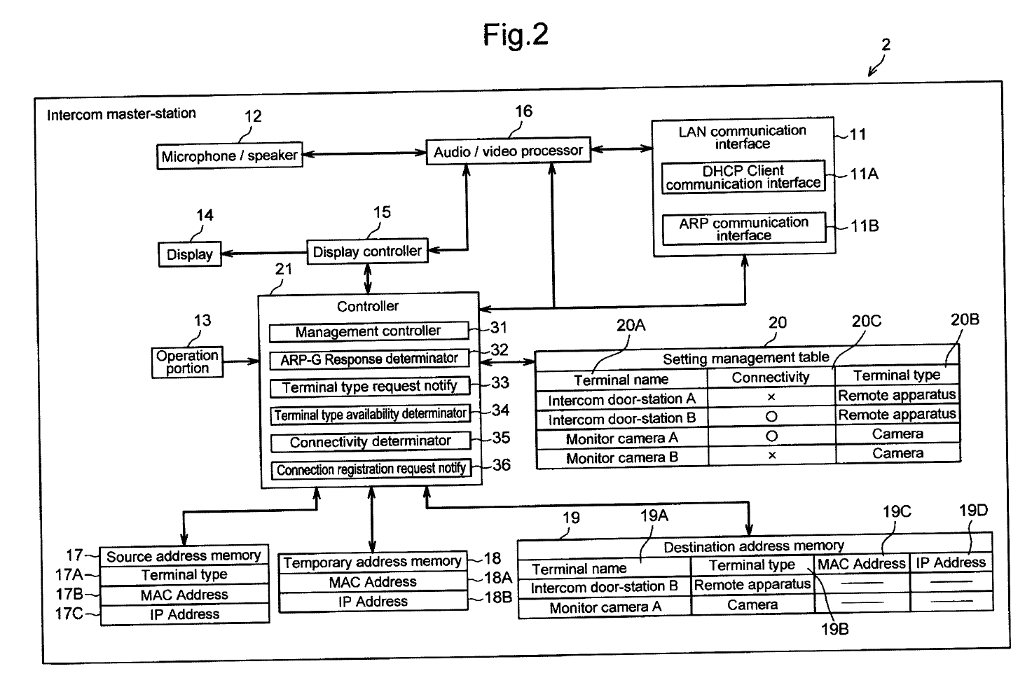

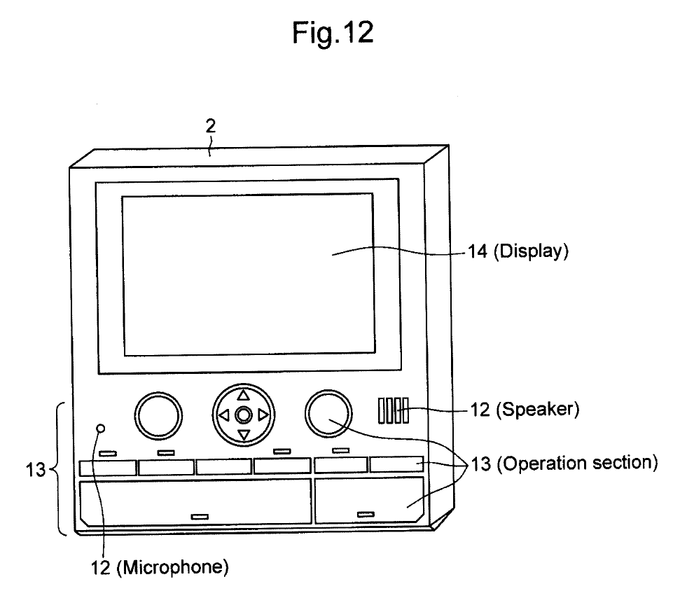

FIG. 2 is a block diagram that illustrates a general configuration of an inside of intercom master-station 2. FIG. 12 is a perspective external view of intercom master-station 2.

Intercom master-station 2 shown in FIGS. 2 and 12 includes LAN communication interface 11, microphone/speaker 12, operation section 13, display 14, display controller 15, audio/video processor 16, source address memory 17, temporary address memory 18, destination address memory 19, setting management table 20, and controller 21. LAN communication interface 11 functions as a communication interface with Regidential LAN 5. Microphone/speaker 12 executes a door phone communication with intercom door-station 3. Operation section 13 has buttons and keys for inputting a variety of instructions. Display 14 displays, on a screen, information such as an image and the like. Display controller 15 controls display 14. Audio/video processor 16 demodulates and modulates communication voice and image through microphone/speaker 12 and display controller 15. Source address memory 17 stores a source address. Temporary address memory 18 temporarily registers a destination address. Destination address memory 19 formally registers the destination address. Setting management table 20 sets and manages connectivity information that identifies connectivity with intercom master-station 2. Controller 21 controls an entirety of intercom master-station 2.

LAN communication interface 11 includes DHCP client communication interface 11A and ARP communication interface 11B. DHCP client communication interface 11A functions as a communication interface with the DHCP communication server function of router 7 via Regidential LAN 5. ARP communication interface 11B functions as an ARP communication interface for an ARP packet and the like via Regidential LAN 5.

DHCP client communication interface 11A notifies router 7 of an address assignment request that requests the DHCP communication server function of router 7 to assign an IP address. In response to the address assignment request, DHCP client communication interface 11A obtains a new IP address from router 7.

In addition to performing normal ARP and ARP response, ARP communication interface 11B has an ARP-G function that performs ARP-G. ARP-G is an ARP request that has an IP address of a source terminal as a target address so as to avoid an IP address conflict thereof.

Source address memory 17 stores terminal type 17A, which indicates terminal type information of the source terminal, that is, intercom master-station 2; MAC address 17B of the source terminal, intercom master-station 2; and IP address 17C of the source terminal, intercom master-station 2. Terminal type 17A and MAC address 17B, which are unique to the intercom master-station, are preset at factory, while IP address 17C corresponds to an IP address automatically assigned by the DHCP server function of router 7.

Setting management table 20 sets and manages terminal name 20A, which identifies a terminal connected to the source terminal, indoor monitor terminal 2, such as, for example, intercom door-station 3, monitor camera 4, and the like; terminal type 20B, which indicates terminal type information of the connected terminal; and connectivity 20C, which sets connectivity of the connected terminal to the source terminal, indoor monitor terminal 2.

In the system shown in FIG. 1, for instance, intercom master-station A is set to communicate and connect with intercom door-station B and monitor camera A; and intercom master-station B is set to communicate and connect with intercom door-station A. In setting management table 20 of intercom master-station A, connectivity 20C of intercom door-station B and monitor camera A is set to connectable ∘, and connectivity 20C of intercom door-station A and monitor camera B to unconnectable x. A user of intercom master-station 2 can set and change terminal name 20A, terminal type 20B, and connectivity 20C, on the setting screen using operation screen 13.

Destination address memory 19 formally registers terminal name 19A of a destination terminal with which the source terminal, intercom master-station 2, communicates; terminal type 19B, which indicates terminal type information of the destination terminal; MAC address 19C of the destination terminal; and IP address 19D of the destination terminal.

Temporary address memory 18 temporarily registers MAC address 18A and IP address 18B of the destination terminal, before the addresses are formally registered in destination address memory 19.

Controller 21 includes management controller 31, ARP-G response determinator 32, terminal type request notifier 33, terminal type availability determinator 34, connectivity determinator 35, and connection registration request notifier 36. Management controller 31 controls source address memory 17, temporary address memory 18, destination address memory 19, and setting management table 20. In order to avoid an IP address conflict of the source terminal as being assigned through the DHCP protocol, ARP-G response determinator 32 determines whether or not a response to ARP-G is detected within a predetermined time, after ARP-G, which includes the source IP address as the target address, is broadcasted through ARP communication interface 11B. When ARP-G is detected from a terminal other than the source terminal on Regidential LAN 5 through ARP communication interface 11B, terminal type request notifier 33 notifies, through LAN communication interface 11, a terminal type request that requests the terminal related to ARP-G to provide terminal type information. When a terminal type response to the terminal type request is received from the terminal apparatus through LAN communication interface 11, terminal type availability determinator 34 determines whether or not the terminal type information of the terminal apparatus included in the terminal type response is in setting management table 20. When terminal type availability determinator 34 determines that the terminal type information of the terminal apparatus is in setting management table 20, connectivity determinator 35 determines whether or not the terminal apparatus is capable of connecting to the source terminal, indoor monitor terminal 2. When connectivity determinator 35 determines that the terminal apparatus is capable of connecting to the source terminal, indoor monitor terminal 2, connection registration request notifier 36 notifies the terminal apparatus of a registration request for connection through LAN communication interface 11. Controller 21 is implemented by a single micro processor and some programs corresponding to management controller 31, ARP-G response determinator 32, terminal type request notifier 33, terminal type availability determinator 34, connectivity determinator 35 and connection registration request notifier 36. However, a plurality of processors can be used for management controller 31, ARP-G response determinator 32, terminal type request notifier 33, terminal type availability determinator 34, connectivity determinator 35 and connection registration request notifier 36.

When ARP-G response determinator 32 determines that no response to ARP-G that includes the source IP address as the target address is detected within the predetermined time, management controller 31 stores, in source address memory 17, the IP address as the source IP address. Conversely, when ARP-G response determinator 32 determines that a response to ARP-G that includes the source IP address as the target address is detected within the predetermined time, management controller 31 determines that the IP address conflicts and instructs the DHCP server function of router 7 to re-assign an IP address.

In addition, when ARP-G is detected from a terminal other than the source terminal on Regidential LAN 5 through ARP communication interface 11B, management controller 31 reads out an IP address and MAC address of the destination terminal, which are included in ARP-G, and then temporarily registers, in temporary address memory 18, the read-out IP address and MAC address of the destination terminal.

When ARP-G is detected from the terminal, terminal type request notifier 33 notifies, in unicast communication, a terminal type request that requests terminal type information to the IP address and MAC address of the terminal (destination terminal), which are temporarily registered in temporary address memory 18, after a predetermined time.

When a terminal type response to the terminal type request is received from the destination terminal through LAN communication interface 11, terminal type availability determinator 34 determines whether or not terminal name 20A or terminal type 20B associated with the terminal type information included in the terminal type response is in setting management table 20.

When terminal type availability determinator 34 determines that terminal name 20A or terminal type 20B associated with the terminal type information of the destination terminal is in setting management table 20, connectivity determinator 35 determines whether or not the destination terminal is capable of connecting to the source terminal, intercom master-station 2, based on connectivity 20C of terminal name 20A or terminal type 20B associated with the terminal type information of the destination terminal.

When connectivity determinator 35 determines that the destination terminal is capable of connecting to the source terminal, intercom master-station 2, management controller 31 correlates the IP address and MAC address of the destination terminal, which are temporarily registered in temporary address memory 18, and terminal name 20A and terminal type 20B of the destination terminal; and then formally registers the IP address and MAC address in destination address memory 19. Management controller 31 also notifies, in unicast communication, a registration request for connection to the IP address and MAC address of the destination terminal formally registered in destination address memory 19, through connection registration request notifier 36.

When terminal type availability determinator 34 determines that the terminal type information of the destination terminal is not in setting management table 20, or when connectivity determinator 35 determines that the destination terminal is incapable of connecting to the source terminal, intercom master-station 2; the management controller 31 discards the IP address and MAC address of the destination terminal apparatus, which are temporarily registered in temporary address memory 18.

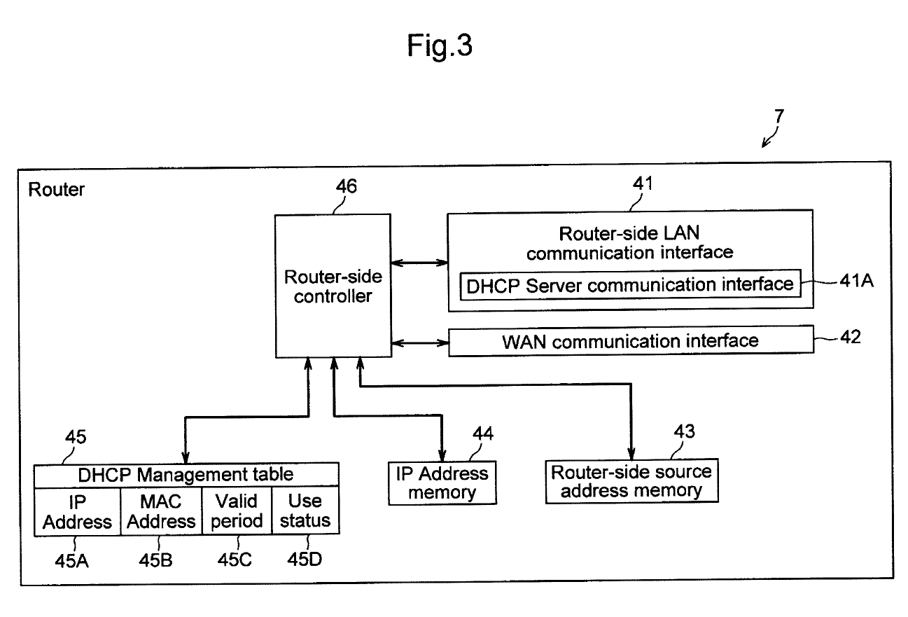

FIG. 3 is a block diagram that illustrates a general configuration of an inside of router 7.

Router 7 shown in FIG. 3 includes router-side LAN communication interface 41, WAN communication interface 42, router-side source address memory 43, IP address memory 44, DHCP management table 45, and router-side controller 46. Router-side LAN communication interface 41 functions as a communication interface with Regidential LAN 5. WAN communication interface 42 functions as a communication interface with WAN 6. Router-side source address memory 43 stores an IP address and MAC address of a source terminal, that is, router 7. IP address memory 44 stores a plurality of IP addresses to be automatically assigned through the DHCP protocol. DHCP management table 45 manages IP address 45A, which is automatically assigned through the DHCP protocol; MAC address 45B of a terminal to which the IP address is assigned; valid period 45C of the IP address; and use status 45D. Router-side controller 46 controls an entirety of router 7.

Router-side LAN communication interface 41 includes DHCP server communication interface 41A, which functions as a communication interface with a DHCP client communication function of a terminal on Regidential LAN 5.

When receiving an IP address assignment request from a terminal on Regidential LAN 5 through DHCP server communication interface 41A, router-side controller 46 automatically selects a new IP address for the terminal from IP address memory 44. Router-side controller 46 then notifies the terminal of the automatically selected new IP address through DHCP server communication interface 41A. Further, router-side controller 46 manages, in DHCP management table 45, the IP address and MAC address of the terminal, valid period, and use status.

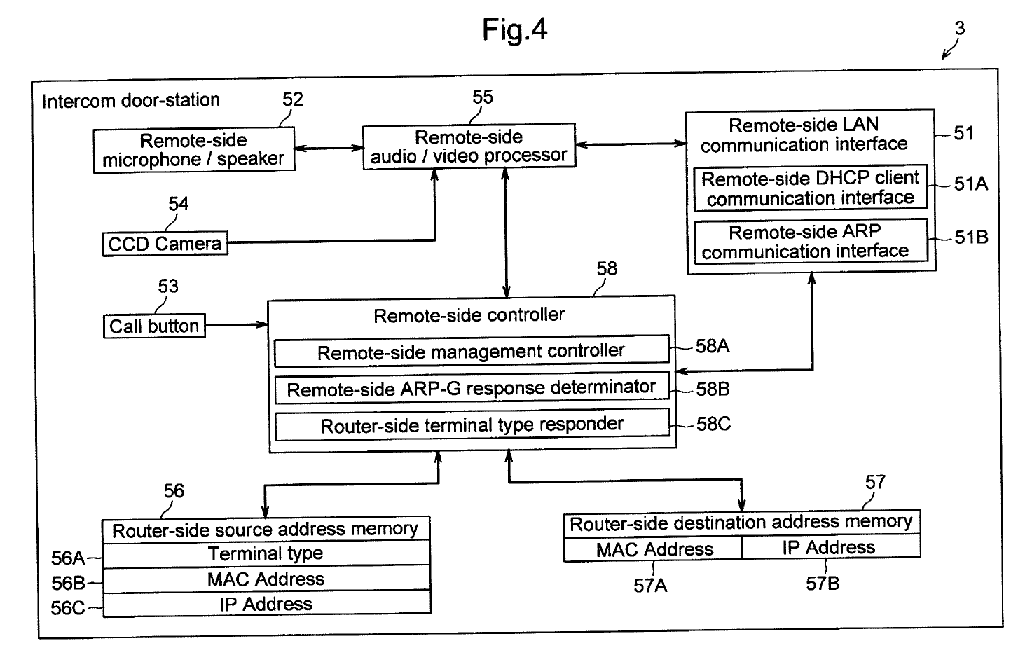

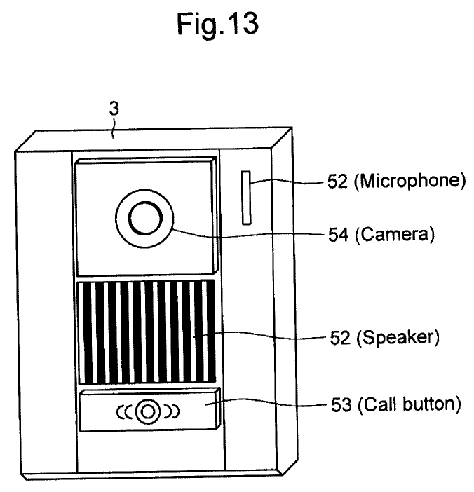

FIG. 4 is a block diagram that illustrates a general configuration of an inside of intercom door-station 3. FIG. 13 is a perspective external view of intercom door-station 3.

Intercom door-station 3 shown in FIGS. 4 and 13 includes remote-side LAN communication interface 51, remote-side microphone/speaker 52, call button 53, CCD camera 54, remote-side audio/video processor 55, remote-side source address memory 56, remote-side destination address memory 57, and remote-side controller 58. Remote-side LAN communication interface 51 functions as a communication interface with Regidential LAN 5. Remote-side microphone/speaker 52 performs a door phone communication, for instance, with intercom master-station 2. Call button 53 provides an instruction to call intercom master-station 2. CCD camera 54 starts shooting an image of a visitor according to, for example, button operation of call button 53. Remote-side audio/video processor 55 demodulates or modulates a call voice signal of remote-side microphone/speaker 52, a call signal of call button 53, a video signal of CCD camera 54, and the like. Remote-side source address memory 56 stores a source address. Remote-side destination address memory 57 registers an address of a destination terminal, with which a source terminal, that is, intercom door-station 3, communicates. Remote-side controller 58 controls an entirety of intercom door-station 3.

Remote-side LAN communication interface 51 includes remote-side DHCP client communication interface 51A and remote-side ARP communication interface 51B. Remote-side DHCP client communication interface 51A functions as a communication interface with the DHCP communication server function of router 7 via Regidential LAN 5. Remote-side ARP communication interface 51B functions as an ARP communication interface for an ARP packet and the like via Regidential LAN 5.

Remote-side DHCP client communication interface 51A notifies an address assignment request to the DHCP communication server function of router 7, and obtains a new IP address from router 7.

In addition to performing normal ARP and ARP response, remote-side ARP communication interface 51B has an ARP-G function that broadcasts ARP-G. ARP-G is an ARP request that includes a source terminal as a target address so as to avoid an IP address conflict thereof.

Remote-side source address memory 56 stores terminal type 56A, which indicates terminal type information of the source terminal, that is, intercom door-station 3; MAC address 56B of the source terminal, intercom door-station 3; and IP address 56C of the source terminal, intercom door-station 3. Terminal type 56A and MAC address 56B, which are unique to the intercom door-station, are preset at factory, while IP address 56C corresponds to an IP address automatically assigned by the DHCP server function of router 7.

Remote-side destination address memory 57 registers MAC address 57A of a destination terminal with which the source terminal, intercom door-station 3, communicates; and IP address 57B of the destination terminal.

Remote-side controller 58 includes remote-side management controller 58A, remote-side ARP-G response determinator 58B, and remote-side terminal type responder 58C. Remote-side management controller 58A controls remote-side source address memory 56 and remote-side destination address memory 57. Remote-side ARP-G response determinator 58B determines whether or not a response to ARP-G is detected within a predetermined time, after ARP-G is broadcasted, the ARP-G including the source IP address assigned through the DHCP protocol as a target address. When a terminal type request is received from, for example, intercom master-station 2 through remote-side LAN communication interface 51, remote-side terminal type responder 58C notifies, in unicast communication, a terminal type response to the IP address and MAC address of intercom master-station 2 included in the terminal type request, the terminal type response including the source terminal type stored in remote-side source address memory 56. Remote-side controller 58 is implemented by a single micro processor and programs corresponding to remote-side management controller 58A, remote-side ARP-G response determinator 58B and remote-side terminal type responder 58C. However, a plurality of processors can be user for remote-side management controller 58A, remote-side ARP-G response determinator 58B and remote-side terminal type responder 58C.

When remote-side ARP-G response determinator 58B determines that no response to ARP-G that includes the source IP address as the target address is detected within the predetermined time, remote-side management controller 58A stores, in remote-side source address memory 56, the IP address as the source IP address. Conversely, when remote-side ARP-G response determinator 58B determines that a response to ARP-G that includes the source IP address as the target address is detected within the predetermined time, remote-side management controller 58A determines that the IP address conflicts and instructs the DHCP server function of router 7 to re-assign an IP address.

When a terminal type request is received from, for example, intercom master-station 2 through remote-side LAN communication interface 51, remote-side terminal type responder 58C reads out the terminal type stored in remote-side source address memory 56, and notifies, in unicast communication, a terminal type response that includes the terminal type to the IP address and MAC address of intercom master-station 2 included in the terminal type request, through remote-side LAN communication interface 51.

When a registration request for connection is received from, for example, intercom master-station 2 through remote-side LAN communication interface 51, remote-side management controller 58A stores, in remote-side destination address memory 57, the IP address and MAC address of intercom master-station 2 included in the registration request for connection, as the destination address.

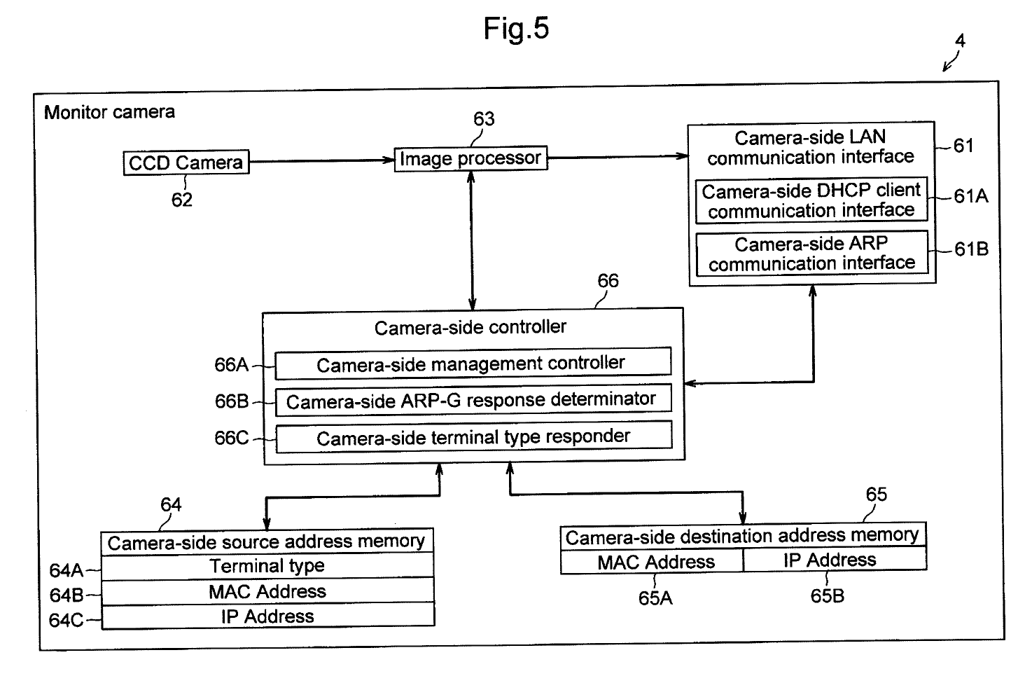

FIG. 5 is a block diagram that illustrates a general configuration of an inside of monitor camera 4.

Monitor camera 4 shown in FIG. 5 includes camera-side LAN communication interface 61, CCD camera 62, image processor 63, camera-side source address memory 64, camera-side destination address memory 65, and camera-side controller 66. Camera-side LAN communication interface 61 functions as a communication interface with Regidential LAN 5. CCD camera 62 shoots an image of a predetermined location. Image processor 63 modulates a video signal of CCD camera 62. Camera-side source address memory 64 stores a source address of a source terminal, that is, monitor camera 4. Camera-side destination address memory 65 registers an address of a destination terminal, with which the source terminal, monitor camera 4, communicates. Camera-side controller 66 controls an entirety of monitor camera 4.

Camera-side LAN communication interface 61 includes camera-side DHCP client communication interface 61A and camera-side ARP communication interface 61B. Camera-side DHCP client communication interface 61A functions as a communication interface with the DHCP server function of router 7 via Regidential LAN 5. Camera-side ARP communication interface 61B functions as an ARP communication interface for an ARP packet and the like via Regidential LAN 5.

Camera-side DHCP client communication interface 61A notifies an IP address assignment request to the DHCP communication server function of router 7, and obtains a new IP address from router 7.

In addition to performing normal ARP and ARP response, camera-side ARP communication interface 61B has an ARP-G function that broadcasts ARP-G. ARP-G is an ARP request that includes an IP address of a source terminal as a target address so as to avoid an IP address conflict thereof.

Camera-side source address memory 64 stores terminal type 64A, which indicates terminal type information of the source terminal, that is, monitor camera 4; MAC address 64B of the source terminal, monitor camera 4; and IP address 64C of the source terminal, monitor camera 4. Terminal type 64A and MAC address 64B, which are unique to the monitor camera, are preset at factory, while IP address 64C corresponds to an IP address automatically assigned by the DHCP server function of router 7.

Camera-side destination address memory 65 registers MAC address 65A of a destination terminal with which the source terminal, monitor camera 4, communicates; and IP address 65B of the destination terminal.

Camera-side controller 66 includes camera-side management controller 66A, camera-side ARP-G response determinator 66B, and camera-side terminal type responder 66C. Camera-side management controller 66A controls camera-side source address memory 64 and camera-side destination address memory 65. Camera-side ARP-G response determinator 66B determines whether or not a response to ARP-G is detected within a predetermined time, after ARP-G is broadcasted, the ARP-G including the source IP address assigned through the DHCP protocol as the target address. When a terminal type request is received from, for example, intercom master-station 2 through camera-side LAN communication interface 61, camera-side terminal type responder 66C notifies, in unicast communication, a terminal type response to the IP address and MAC address of intercom master-station 2 included in the terminal type request, the terminal type response including the source terminal type stored in camera-side source address memory 64. Camera-side controller 66 is implemented by a single micro processor and programs corresponding to camera-side management controller 66A, camera-side ARP-G response determinator 66B and camera-side terminal type responder 66C. However, a plurality of processors can be used for camera-side management controller 66A, camera-side ARP-G response determinator 66B and camera-side terminal type responder 66C.

When camera-side ARP-G response determinator 66B determines that no response to ARP-G that includes the source IP address as the target address is detected within the predetermined time, camera-side management controller 66A stores, in camera-side source address memory 64, the IP address as the source IP address. Conversely, when camera-side ARP-G response determinator 66B determines that a response to ARP-G that includes the source IP address as the target address is detected within the predetermined time, camera-side management controller 66A determines that the IP address conflicts and instructs the DHCP server function of router 7 to re-assign an IP address.

When a terminal type request is received from, for example, intercom master-station 2 through camera-side LAN communication interface 61, camera-side terminal type responder 66C reads out the terminal type stored in camera-side source address memory 64 and notifies, in unicast communication, a terminal type response that includes the terminal type to the IP address and MAC address of intercom master-station 2, through camera-side LAN communication interface 61.

When a registration request for connection is received from, for example, intercom master-station 2 through camera-side LAN communication interface 61, camera-side management controller 66A stores, in camera-side destination address memory 65, the IP address and MAC address of intercom master-station 2 included in the registration request for connection, as the destination address.

In the above-described embodiment of the present invention, the communication system may be provided as door phone system 1; the IP network as Regidential LAN 5; the terminal apparatus as intercom master-station 2, intercom door-station 3, and monitor camera 4; the specific terminal apparatus as intercom master-station 2; the additionally connected terminal apparatus as intercom door-station 3 and monitor camera 4; the setter as setting management table 20; the temporary address memory as temporary address memory 18; the terminal type request notifier as terminal type request notifier 33; the terminal type availability determinator as terminal type availability determinator 34; the connectivity determinator as connectivity determinator 35; the destination address memory as destination address memory 19; the connection registration request notifier as connection registration request notifier 36; the destination address memory on the additionally connected terminal apparatus side as remote-side destination address memory 57 and camera-side destination address memory 65; the broadcast transmitter as ARP communication interface 11B, remote-side ARP communication interface 51B, camera-side ARP communication interface 61B; the ARP-G response determinator as ARP-G response determinator 32, remote-side ARP-G response determinator 58B, and camera-side ARP-G response determinator 66B; the source address memory as source address memory 17, remote-side source address memory 56, and camera-side source address memory 64; the remote-side destination address memory as remote-side destination address memory 57; the remote-side broadcast transmitter as remote-side ARP communication interface 51B; the remote-side response determinator as remote-side response determinator 58B; the remote-side source address memory as remote-side source address memory 56; the camera-side broadcast transmitter as camera-side ARP communication interface 61B; the camera-side ARP-G response determinator as camera-side ARP-G response determinator 66B; the camera-side source address memory as camera-side source address memory 64; and the display as display 14.

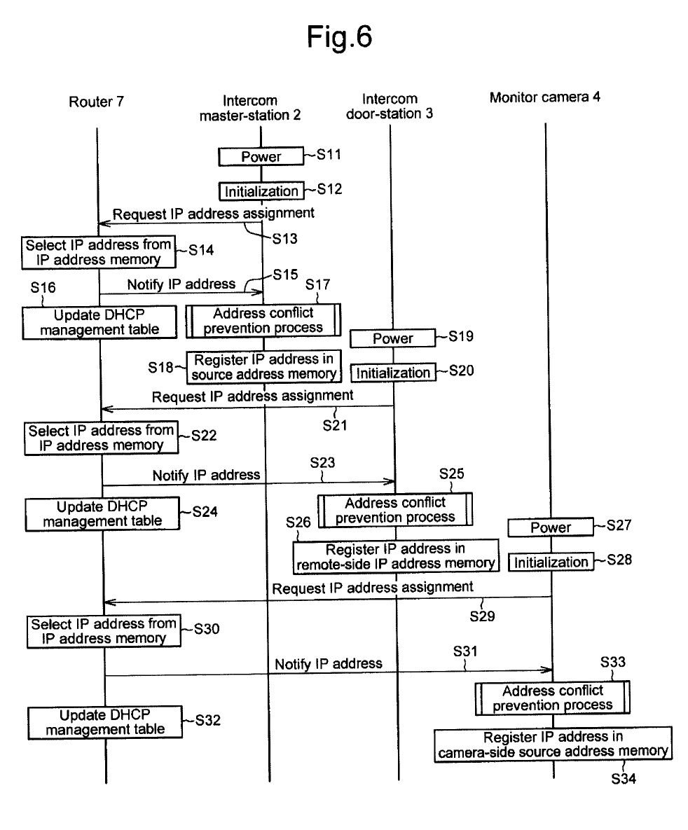

Operations of door phone system 1 according to the present embodiment are explained below. FIG. 6 is a sequence diagram that briefly illustrates process operations of router 7, intercom master-station 2, intercom door-station 3, and monitor camera 4, relating to an automatic IP address assignment process according to the present embodiment.

The automatic IP address assignment process shown in FIG. 6 is a process where router 7 automatically assigns IP addresses to intercom master-station 2, intercom door-station 3, and monitor camera 4 on Regidential LAN 5, in response to an IP address assignment request to router 7.

In FIG. 6, when intercom master-station 2 detects the power is on thereon (Step S11), intercom master-station 2 executes initialization (Step S12) and notifies router 7 of an IP address assignment request through DHCP client communication interface 11A via Regidential LAN 5 (Step S13).

When receiving the IP address assignment request from intercom master-station 2 through DHCP server communication interface 41A, router-side controller 46 of router 7 selects an unused new IP address from IP address memory 44, based on information in DHCP management table 45 (Step S14). Router-side controller 46 then notifies intercom master-station 2 of the selected new IP address through DHCP server communication interface 41A (Step S15), and updates DHCP management table 45 in order to update the use status of the IP address (Step S16).

When receiving the new IP address, intercom master-station 2 executes a process for address conflict prevention (described hereinafter), so that the new IP address does not conflict on Regidential LAN 5 (Step S117).

After executing the process for address conflict prevention of Step S17, management controller 31 of intercom master-station 2 stores, in source address memory 17, the new IP address having no conflict as the IP address of the source terminal, intercom master-station 2 (Step S18). Thereby, intercom master-station 2 has confirmed the source IP address.

Subsequently, when intercom door-station 3 detects the power is on thereon (Step S19), intercom door-station 3 executes initialization (Step S20) and notifies router 7 of an IP address assignment request through remote-side DHCP client communication interface 51A via Regidential LAN 5 (Step S21).

When receiving the IP address assignment request from intercom door-station 3 through DHCP server communication interface 41A, router-side controller 46 of router 7 selects an unused new IP address from IP address memory 44, based on the information in DHCP management table 45 (Step S22). Router-side controller 46 then notifies intercom door-station 3 of the selected new IP address through DHCP server communication interface 41A (Step S23), and updates DHCP management table 45 in order to update the use status of the IP address (Step S24).

When receiving the new IP address, intercom door-station 3 executes the process for address conflict prevention (described hereinafter), so that the IP address does not conflict on Regidential LAN 5 (Step S25).

After executing the process for address conflict prevention of Step S25, remote-side management controller 58A of intercom door-station 3 stores, in remote-side source address memory 56, the new IP address having no conflict as the IP address of the source address, intercom door-station 3 (Step S26). Thereby, intercom door-station 3 has registered the source IP address.

Subsequently, when monitor camera 4 detects the power is on thereon (Step S27), monitor camera 4 executes initialization (Step S28) and notifies router 7 of an IP address assignment request through camera-side DHCP client communication interface 61A via Regidential LAN 5 (Step S29).

When receiving the IP address assignment request from monitor camera 4 through DHCP server communication interface 41A, router-side controller 46 of router 7 selects an unused new IP address from IP address memory 44, based on the information in DHCP management table 45 (Step S30). Router-side controller 46 then notifies monitor camera 4 through DHCP server communication interface 41A of the selected new IP address (Step S31), and updates DHCP management table 45 in order to update the use status of the IP address (Step S32).

When receiving the new IP address, monitor camera 4 executes the process for address conflict prevention (described hereinafter) so that the IP address does not conflict on Regidential LAN 5 (Step S33).

After executing the process for address conflict prevention of Step S33, camera-side management controller 66A of monitor camera 4 stores, in camera-side source address memory 64, the new IP address having no conflict as the IP address of the source terminal, monitor camera 4 (Step S34). Thereby, monitor camera 4 has registered the source IP address.

In the automatic IP address assignment process shown in FIG. 6, router 7 sequentially assigns IP addresses to intercom master-station 2, intercom door-station 3, and monitor camera 4 on Regidential LAN 5, using the DHCP protocol; and intercom master-station 2, intercom door-station 3, and monitor camera 4, to which the IP addresses are assigned, execute the process for IP address conflict prevention. Thereby, IP addresses can be assigned to intercom master-station 2, intercom door-station 3, and monitor camera 4 on Regidential LAN 5, with no cumbersome work.

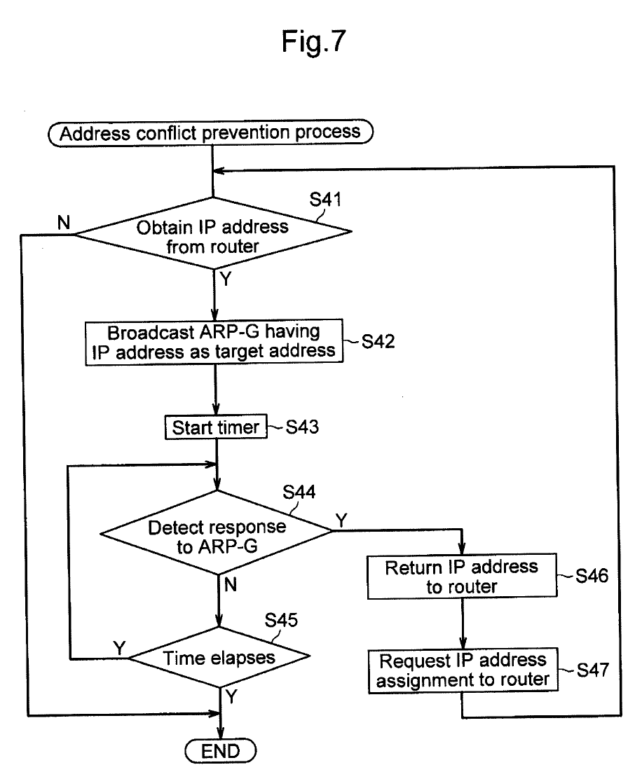

Process operations are explained below relating to the process for address conflict prevention of Steps S17, S25, and S33 shown in FIG. 6. FIG. 7 is a flowchart that illustrates process operations inside intercom master-station 2, relating to the address conflict prevention process of Step S17. The address conflict prevention process of Step S25 is performed in intercom door-station 3, and that of Step S33 in monitor camera 4. Since the main process operations are the same, overlapping explanations are omitted.

The address conflict prevention process shown in FIG. 7 is a process for preventing an IP address conflict from occurring on Regidential LAN 5, when router 7 sequentially assigns IP addresses to intercom master-station 2, intercom door-station 3, and monitor camera 4, using the DHCP protocol.

In FIG. 7, management controller 31 of intercom master-station 2 determines whether or not an IP address is obtained from router 7 through DHCP client communication interface 11A (Step S41).

When it is determined that the IP address is obtained, controller 21 broadcasts ARP-G that includes the IP address as the target address to Regidential LAN 5 through ARP communication interface 11B (Step S42), and starts a timer to count a predetermined time after the broadcast of ARP-G (Step S43).

ARP-G response determinator 32 of controller 21 determines whether or not a response to the ARP-G is detected through ARP communication interface 11B (Step S44).

When no response to the ARP-G is detected at ARP-G response determinator 32, management controller 31 of controller 21 determines whether or nor the predetermined time started in Step S43 has elapsed (Step S45).

When determining that the predetermined time has elapsed, management controller 31 determines that the IP address does not conflict on Regidential LAN 5, since there is no response to the ARP-G that included the source IP address as the target address, and thus ends the process operations.

When determining that the predetermined time has not elapsed in Step 45, management controller 31 proceeds to Step S44 in order to continue to monitor whether or not a response to the ARP-G is detected.

When a response to the ARP-G is detected in Step S44, management controller 31 determines that the IP address conflicts on Regidential LAN 5, and thus notifies router 7 of an IP address return notice through DHCP client communication interface 11A, in order to return the assigned new address to router 7 (Step S46). Management controller 31 also notifies router 7 of an IP address assignment request in order to request a new IP address assignment (Step S47), and then proceeds to Step S41 in order to monitor whether or not a new IP address is obtained from router 7.

When determining that no new IP address is obtained from router 7 within the predetermined time in Step S41, controller 21 ends the process operations.

The address conflict prevention process of Step S17 was explained with reference to FIG. 7. In the address conflict prevention process of Step S25, intercom master-station 2 is replaced with intercom door-station 3; management controller 31 with remote-side management controller 58A; controller 21 with remote-side controller 58; ARP-G response determinator 32 with remote-side ARP-G response determinator 58B; and DHCP client communication interface 11A with remote-side DHCP client communication interface 51A. In the address conflict prevention process of Step S33, intercom master-station 2 is replaced with monitor camera 4; management controller 31 with camera-side management controller 66A; controller 21 with camera-side controller 66; ARP-G response determinator 32 with camera-side ARP-G response determinator 66B; and DHCP client communication interface 11A with camera-side DHCP client communication interface 61A. Thus, the overlapping explanations are omitted.

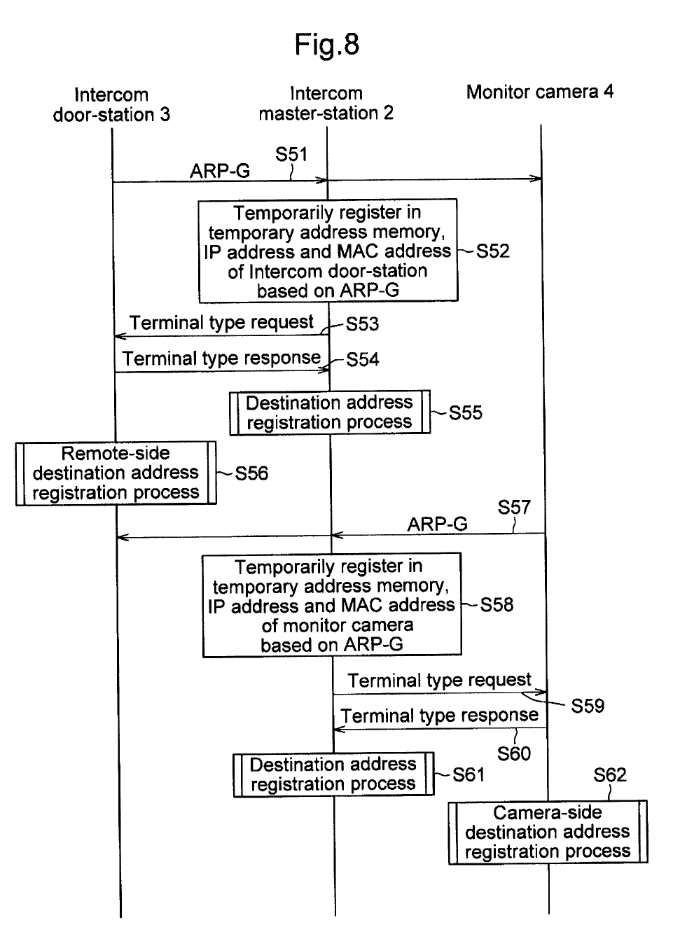

Process operations of intercom master-station 2, intercom door-station 3, and monitor camera 4 are explained below, relating to an address registration process. In the process, destination addresses are registered in intercom master-station 2, intercom door-station 3, and monitor camera 4, after IP addresses are assigned. FIG. 8 is a sequence diagram that illustrates the process operations of intercom master-station 2, intercom door-station 3, and monitor camera 4, relating to the address registration process.

The address registration process shown in FIG. 8 is the process where the destination addresses are registered in intercom master-station 2, intercom door-station 3, and monitor camera 4, after the IP addresses are automatically assigned.

In FIG. 8, when detecting ARP-G broadcasted from, for example, intercom door-station 3, through ARP communication interface 11B (Step S51), management controller 31 of intercom master-station 2 obtains an IP address and MAC address included in the ARP-G, and then temporarily registers, in temporary address memory 18, the obtained IP address and MAC address (Step S52). The ARP-G in Step S51 corresponds to the ARP-G used in the address conflict prevention process of intercom door-station 3.

When the IP address and MAC address are temporarily registered in temporary address memory 18, terminal type request notifier 33 notifies, in unicast communication, a terminal type request that requests terminal type information, to the IP address and MAC address temporarily registered in temporary address memory 18 through LAN communication interface 11 (Step S53).

When receiving the terminal type request from intercom master-station 2 through remote-side LAN communication interface 51, remote-side management controller 58A of intercom door-station 3 reads out, from remote-side source address memory 56, a terminal type of a source terminal, intercom door-station 3, in response to the terminal type request. Then, remote-side management controller 58A notifies, in unicast communication, a terminal type response that includes the terminal type, to intercom master-station 2 having the IP address and MAC address included in the terminal type request (Step S54).

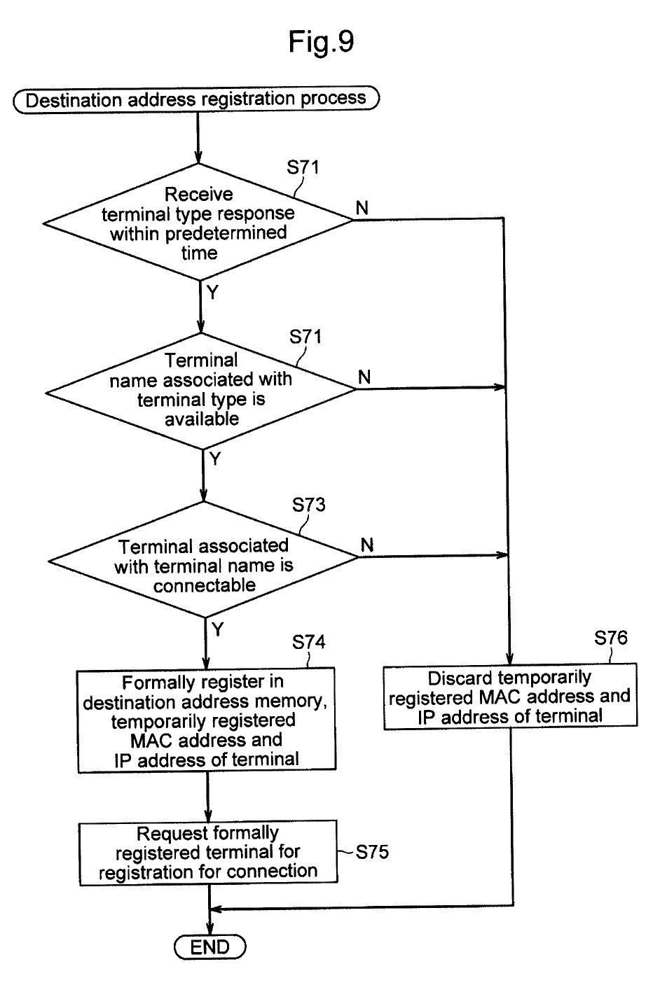

When receiving the terminal type response through LAN communication interface 11, the controller of intercom master-station 2 executes a destination address registration process shown in FIG. 9, based on the terminal type included in the terminal type response (Step S55).

FIG. 9 is a flowchart that illustrates process operations of controller 21, relating to the destination address registration process of intercom master-station 2.

The destination address registration process shown in FIG. 9 is a process where a destination IP address and MAC address temporarily registered in temporary address memory 18 are formally registered in destination address memory 19, according to terminal type information of a destination terminal provided in a terminal type response.

In FIG. 9, after notifying the terminal type request in Step S53, management controller 31 of intercom master-station 2 determines whether or not a terminal type response is received within a predetermined time through LAN communication interface 11 (Step S71).

When determining that the terminal type response is received within the predetermined time, management controller 31 determines whether or not terminal name 20A associated with terminal type information included in the terminal type response is in setting management table 20 (Step S72).

When determining that terminal name 20A associated with the terminal type information included in the terminal type response is in setting management table 20, management controller 31 determines whether or not a terminal associated with terminal name 20A is connectable “∘” to intercom master-station 2, based on connectivity 20C associated with terminal name 20A (Step S73).

When determining that the terminal associated with terminal name 20A is connectable to intercom master-station 2, management controller 31 formally registers, in destination address memory 19, the IP address and MAC address temporarily registered in temporary address memory 18 as a destination terminal (Step S74).

When the IP address and MAC address of the destination terminal are formally registered in destination address memory 19, connection registration request notifier 36 notifies, in unicast communication, a registration request for connection to the formally registered IP address or MAC address of the terminal (Step S75), and then ends the process operations.

When determining that no terminal type response is received within the predetermined time in Step S71, when determining that terminal name 20A associated with the terminal type information included in the terminal type response is not in setting management table 20 in Step S72, or when determining that the terminal associated with terminal name 20A is unconnectable to intercom master-station 2 in Step S73; management controller 31 discards the address of the terminal, that is, the IP address and MAC address temporarily registered in temporary address memory 18 (Step S76), and then ends the process operations.

In the destination address registration process shown in FIG. 9, when it is determined that terminal name 20A associated with the terminal type information included in the terminal type response from the destination terminal is in setting management table 20, and that the terminal is connectable to intercom master-station 2, based on connectivity 20C of the terminal associated with terminal name 20A; the terminal address, that is, the IP address and MAC address temporarily registered in temporary address memory 18, are formally registered in destination address memory 19 as the destination address. Thereby, the IP address and MAC address of the destination terminal can be registered in intercom master-station 2.

In addition, in the destination address registration process, when it is determined that no terminal type response is received from the destination terminal within the predetermined time, that terminal name 20A associated with terminal type information included in the terminal type response is not in setting management table 20, or that the terminal associated with terminal name 20A is unconnectable to intercom master-station 2; the IP address and MAC address temporarily registered in temporary address memory 18 are discarded. Thereby, intercom master-station 2 can register as the destination terminal, only the terminal whose IP address and MAC address are set in setting management table 20.

As described above, controller 21 of intercom master-station 2 shown in FIG. 8 executes the destination address registration process of Step S55, and thereby formally registers, in destination address memory 19, the IP address and MAC address of the destination terminal, intercom door-station 3.

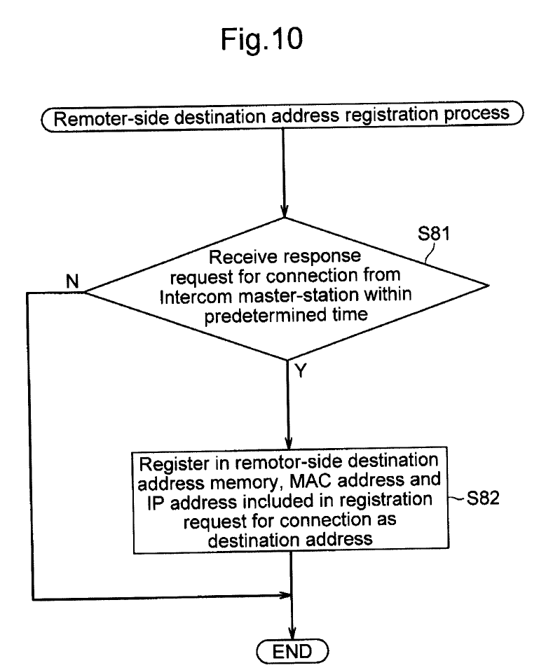

Further, when receiving the registration request for connection from intercom master-station 2 through remote-side LAN communication interface 51, remote-side management controller 58A of intercom door-station 3 executes a remote-side destination address registration process shown in FIG. 10 (Step S56).

FIG. 10 is a flowchart that illustrates process operations inside remote-side management controller 58A, relating to the remote-side destination address registration process of intercom door-station 3.

The remote-side destination address registration process shown in FIG. 10 is a process where, when a registration request for connection is received from intercom master-station 2, an IP address and MAC address included in the registration request for connection are registered in remote-side destination address memory 57.

In FIG. 10, remote-side management controller 58A of intercom door-station 3 determines whether or not the registration request for connection is received from intercom master-station 2 within a predetermined time from a terminal type response, through remote-side LAN communication interface 51 (Step S81).

When determining that the registration request for connection is received from intercom master-station 2, remote-side management controller 58A registers, in remote-side destination address memory 57, the IP address and MAC address included in the registration request for connection, that is, the address of intercom master-station 2, as a destination address (Step S82), and then ends the process operations.

In the remote-side destination address registration process shown in FIG. 10, when the registration request for connection is received from intercom master-station 2, the IP address and MAC address of intercom master-station 2 included in the registration request for connection are registered as the destination address in remote-side destination address memory 57. Thereby, the IP address and MAC address of intercom master-station 2 can be registered as the destination terminal in intercom door-station 3.

Remote-side management controller 58A of intercom door-station 3 shown in FIG. 8 executes the remote-side destination address registration process of Step S56, and thereby registers, in remote-side destination address memory 57, the IP address and MAC address of the destination terminal, intercom master-station 2.

Further, when detecting ARP-G broadcasted from, for example, intercom master-station 2, through ARP communication interface 11B (Step S57), management controller 31 of intercom master-station 2 obtains an IP address and MAC address included in the ARP-G, and then temporarily registers, in temporary address memory 18, the obtained IP address and MAC address (Step S58). The ARP-G in Step S57 corresponds to the ARP-G used in the address conflict prevention process of monitor camera 4.

When the IP address and MAC address are temporarily registered in temporary address memory 18, terminal type request notifier 33 notifies, in unicast communication, a terminal type request that requests terminal type information, to the IP address and MAC address temporarily registered in temporary address memory 18 through LAN communication interface 11 (Step S59).

When receiving the terminal type request from intercom master-station 2 through camera-side LAN communication interface 61, camera-side management controller 66A of monitor camera 4 reads out, from camera-side source address memory 64, a terminal type of a source terminal, monitor camera 4, in response to the terminal type request. Then, camera-side management controller 66A notifies, in unicast communication, a terminal type response that includes the terminal type, to intercom master-station 2 having the IP address and MAC address included in the terminal type request (Step S60).

When receiving the terminal type response through LAN communication interface 11, controller 21 of intercom master-station 2 executes the destination address registration process shown in FIG. 9, based on the terminal type included in the terminal type response (Step S61), and thereby formally registers, in destination address memory 19, the IP address and MAC address of the destination terminal, monitor camera 4.

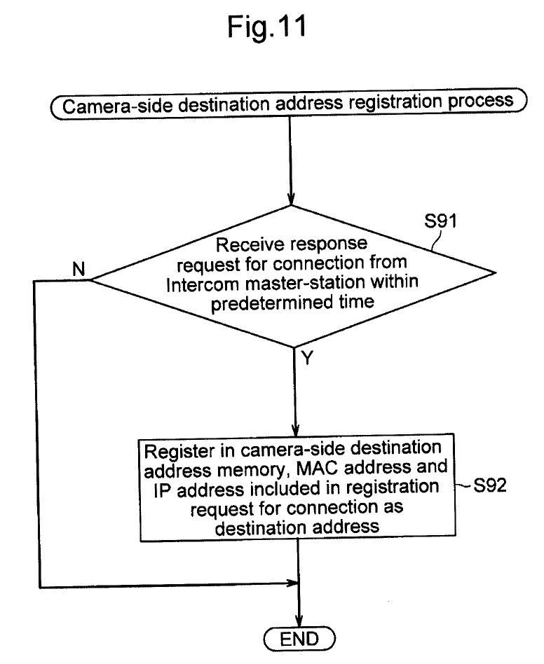

Further, when receiving the registration request for connection from intercom master-station 2 through camera-side LAN communication interface 61, camera-side management controller 66A of monitor camera 4 executes the camera-side destination address registration process shown in FIG. 11 (Step S62).

FIG. 11 is a flowchart that illustrates process operations inside camera-side management controller 66A, relating to the camera-side destination address registration process of monitor camera 4.

The camera-side destination address registration process shown in FIG. 11 is a process where, when a registration request for connection is received from intercom master-station 2, an IP address and MAC address included in the registration request for connection are registered in camera-side destination address memory 65.

In FIG. 11, camera-side management controller 66A of monitor camera 4 determines whether or not the registration request for connection is received from intercom master-station 2 within a predetermined time from a terminal type response through camera-side LAN communication interface 61 (Step S91).

When determining that the registration request for connection is received from intercom master-station 2, camera-side management controller 66A registers, in camera-side destination address memory 65, the IP address and MAC address included in the registration request for connection, that is, the address of intercom master-station 2, as a destination address (Step S92), and then ends the process operations.

In the camera-side destination address registration process shown in FIG. 11, when the registration request for connection is received from intercom master-station 2, the IP address and MAC address of intercom master-station 2 included in the registration request for connection are registered as the destination address in camera-side destination address memory 65. Thereby, the IP address and MAC address of intercom master-station 2 can be registered as the destination terminal in monitor camera 4.

Camera-side management controller 66A of monitor camera 4 shown in FIG. 8 executes the camera-side destination address registration process of Step S62, and thereby registers, in camera-side destination address memory 65, the IP address and MAC address of the destination terminal, intercom master-station 2.

In the present embodiment, intercom master-station 2 has setting management table 20 that sets connectivity 20C with intercom master-station 2, per terminal name 20A that identifies each intercom door-station 3 and monitor camera 4. When the DHCP protocol is used to automatically assign IP addresses to intercom master-station 2, intercom door-station 3, and monitor camera 4 on Regidential LAN 5, intercom master-station 2 detects ARP-G from intercom door-station 3 (monitor camera 4), which is additionally connected to Regidential LAN 5, and then temporarily registers the IP address and MAC address of intercom door-station 3 (monitor camera 4), which are included in the ARP-G. Intercom master-station 2 then notifies the terminal type request that includes the IP address and MAC address of intercom master-station 2, in order to request intercom door-station 3 (monitor camera 4) having the temporarily registered IP address and MAC address, to provide the terminal type information. When receiving the terminal type response to the terminal type request from the destination terminal, intercom master-station 2 determines whether or not setting management table 20 stores terminal name 20A associated with the terminal type information of intercom door-station 3 (monitor camera 4), which is included in the terminal type response. When determining that setting management table 20 stores terminal name 20A associated with the terminal type information of intercom door-station 3 (monitor camera 4), intercom master-station 2 determines whether or not the terminal type of intercom door-station 3 (monitor camera 4) is capable of connecting to intercom master-station 2, based on connectivity 20C associated with the terminal name 20A. When determining that the terminal type of intercom door-station 3 (monitor camera 4) is capable of connecting to intercom master-station 2, intercom master-station 2 formally registers the IP address and MAC address of intercom door-station 3 (monitor camera 4), which are temporarily registered, as the destination address. Intercom master-station 2 then notifies the registration request for connection to enable connection with intercom master-station 2, to the IP address and MAC address of intercom door-station 3 (monitor camera 4), which are formally registered. When intercom door-station 3 (monitor camera 4) receives the registration request for connection from intercom master-station 2, intercom door-station 3 (monitor camera 4) registers, in remote-side destination address memory 57 (camera-side destination address memory 65), the IP address and MAC address related to intercom master-station 2, which are included in the registration request for connection, as the destination address. Thereby, a user of intercom master-station 2, intercom door-station 3, and monitor camera 4 can register the destination addresses in intercom master-station 2, intercom door-station 3, and monitor camera 4 with no workload related to IP address assignment, based on the set information in setting management table 20, even in door phone system 1 for a plurality of households, which includes a plurality of intercom master-stations 2, a plurality of intercom door-stations 3, and a plurality of monitor cameras 4. Thus, the workload can substantially be reduced for registering the destination addresses in intercom master-stations 2, intercom door-stations 3, and monitor cameras 4.

In the present embodiment, when intercom master-station 2 (intercom door-station 3 and monitor camera 4) is automatically assigned with an IP address through the DHCP protocol in order to additionally connect to Regidential LAN 5, intercom master-station 2 (intercom door-station 3 and monitor camera 4) performs broadcast transmission of ARP-G having the IP address as the target address. When detecting no response to the ARP-G within the predetermined time, intercom master-station 2 (intercom door-station 3 and monitor camera 4) stores, in source address memory 17 (remote-side source address memory 56 and camera-side source address memory 64), the IP address, which is automatically assigned associated with the source MAC address, as the source address. When detecting a response to the ARP-G, intercom master-station 2 (intercom door-station 3 and monitor camera 4) discards the automatically assigned IP address. Thereby, even when the IP address is automatically assigned through the DHCP protocol in order to additionally connect to Regidential LAN 5, intercom master-station 2 (intercom door-station 3 and monitor camera 4) can avoid an IP address conflict on Regidential LAN 5.

In the present embodiment, intercom master-station 2 uses the destination IP address or MAC address, which is formally stored in destination address memory 19, so as to connect and communicate with the destination terminal apparatus, such as, for example, intercom door-station 3 and monitor camera 4; and intercom door-station 3 (monitor camera 4) uses the destination IP address or MAC address, which is stored in remote-side destination address memory 57 (camera-side destination address memory 65), so as to connect and communicate with intercom master-station 2. Thereby, address input operation is not required on intercom master-station 2, intercom door-station 3, and monitor camera 4, to receive a call and image from door monitor apparatus 3 as well as to receive an image from monitor camera 4.

In addition, in the present embodiment, information in setting management table 20 is displayed on display 14. Thereby, a user of intercom master-station 2 can recognize connectivity 20C per terminal name 20A, based on the information displayed on display 14.

Further, in the present embodiment, the DHCP server function of router 7 is used to sequentially assign IP addresses to intercom master-station 2, intercom door-station 3, and monitor camera 4 on Regidential LAN 5. When valid period 45C in DHCP management table 45 shown in FIG. 3 elapses, an assigned IP address is discarded and a new IP address is sequentially assigned. Intercom master-station 2, intercom door-station 3, and monitor camera 4 also register MAC addresses along with destination IP addresses, thus allowing the apparatuses to secure a communication based on the MAC addresses, even when the destination IP addresses change as the valid period elapses.

In the above-described embodiment, intercom master-station 2 cannot recognize unicast communications between other terminal apparatuses, and thus cannot recognize a response to ARP-G from the other terminal apparatuses. When provided with the promiscuous mode setter, which sets intercom master-station 2 to the promiscuous mode that allows monitoring of unicast communications among the other terminal apparatuses, however, intercom master-station 2 can recognize a response to ARP-G from the other terminal apparatuses. Thus, when detecting a response to ARP-G from intercom door-station 3 (monitor camera 4) during the promiscuous mode, intercom master-station 2 determines that the IP address of intercom door-station 3 (monitor camera 4) conflicts, and thereby discard the IP address and MAC address of intercom door-station 3 (monitor camera 4) temporarily registered in temporary address memory 18.

Door phone system 1 was used as an example in the above-described embodiment, where intercom master-station 2, intercom door-station 3, and monitor camera 4 are located on Regidential LAN 5. However, the similar effects are obtained in a door phone system that provides no image, where an intercom master-station and intercom door-station are included.

Door phone system 1 in the above-described embodiment, where intercom master-station 2, intercom door-station 3, and monitor camera 4 are located on Regidential LAN 5, is merely a non-limiting example. The similar effects are obtained in a communication system, where a plurality of terminal apparatuses are connected to an IP network.

It is noted that the foregoing examples have been provided merely for the purpose of explanation and are in no way to be construed as limiting of the present invention. While the present invention has been described with reference to exemplary embodiments, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular structures, materials and embodiments, the present invention is not intended to be limited to the particulars disclosed herein; rather, the present invention extends to all functionally equivalent structures, methods and uses, such as are within the scope of the appended claims.

The present invention is not limited to the above described embodiments, and various variations and modifications may be possible without departing from the scope of the present invention.

This application is based on the Japanese Patent Application No. 2007-003243 filed on Jan. 11, 2007, entire content of which is expressly incorporated by reference herein.

What is claimed is:

1. A communication system comprises a first terminal apparatus and a second terminal apparatus connected to an IP network, a first IP address and a second IP address being assigned to the first terminal apparatus and the second terminal apparatus respectively by using a DHCP protocol,
wherein the first terminal apparatus comprises;
a connectivity information memory that stores connectivity information on the second terminal apparatus, the connectivity information indicating if the second terminal apparatus can connect with the first terminal apparatus;
a buffer memory that stores the second IP address sent from the second terminal apparatus;
a first destination address memory that stores a first destination address for the second terminal apparatus,
a controller that sends a request to the second terminal apparatus by using the second IP address stored in the buffer memory to obtain a terminal information of the second terminal apparatus, determines if the second terminal apparatus can be connected with the first terminal apparatus according to the connectivity information stored in the connectivity information memory and the terminal information received from the second terminal apparatus, stores the second IP address in the buffer memory into the first destination address memory as the first destination address and sends a registration request to the second terminal apparatus, the registration request including the first IP address;
wherein the second terminal apparatus comprises;
a second destination address memory that stores a second destination address, the first IP address being stored in the second destination address as the second destination address when the second terminal apparatus receives the registration request from the first terminal apparatus.

2. The communication system according to claim 1, wherein the second terminal apparatus further comprises;
a transmitter that broadcasts the second IP address on the IP network,
a detector that detects a response from the IP network in response to the broadcasted second IP address, and
a IP address memory that stores the second IP address, the second IP address being stored in the IP address memory if the detector does not detect the response within a predetermined time period.

3. The communication system according to claim 2, wherein the controller monitors a communication between the second terminal apparatus and a third terminal apparatus connected to the IP network and discards the second IP address stored in the buffer memory when the controller detects a response signal from the third terminal apparatus to the second terminal apparatus, the response signal being transmitted from the third terminal apparatus to the second terminal apparatus in response to the second IP address sent from the second terminal apparatus to the third terminal apparatus.

4. The communication system according to claim 1, wherein the first terminal apparatus communicates to the second terminal according to the first destination address and the second terminal apparatus communicates to the first terminal apparatus according to the second destination address.

5. The communication system according to claim 1, wherein the terminal information includes terminal identification information and terminal attribution information.

6. A communication system comprises an intercom master-station and a intercom door-station connected to an IP network, a first IP address and a second IP address being assigned to the intercom master-station and the intercom door-station respectively by using a DHCP protocol,
wherein the intercom master-station comprises;
a connectivity information memory that stores connectivity information on the intercom door-station, the connectivity information indicating if the intercom door-station can connect with the intercom master-station;
a buffer memory that stores the second IP address sent from the intercom door-station;
a first destination address memory that stores a first destination address for the intercom door-station,
a controller that sends a request to the intercom door-station by using the second IP address stored in the buffer memory to obtain a station information of the intercom door-station, determines if the intercom door-station can be connected with the intercom master-station according to the connectivity information stored in the connectivity information memory and the station information received from the intercom door-station, stores the second IP address in the buffer memory into the first destination address memory as the first destination address and sends a registration request to the intercom door-station, the registration request including the first IP address;
wherein the intercom door-station comprises;
a second destination address memory that stores a second destination address, the first IP address being stored in the second destination address as the second destination address when the intercom door-station receives the registration request from the intercom master-station.

7. A communication system comprises a plurality of intercom master-stations and a plurality of intercom door-stations connected to an IP network, an IP address being assigned to each of the plurality of intercom master-stations and each of the plurality of intercom door-stations respectively by using a DHCP protocol,
wherein the intercom master-station comprises;
a connectivity information memory that stores connectivity information on each of the plurality of intercom door-stations, the connectivity information indicating if the intercom door-station can connect with each of the plurality of intercom master-stations;
a buffer memory that stores a second IP address sent from one of the plurality of intercom door-stations, the second IP address being assigned to the one of the plurality of intercom door-stations;
a first destination address memory that stores a first destination address for the intercom door-station,
a controller that sends a request to the one of the plurality of intercom door-stations by using the second IP address stored in the buffer memory to obtain a station information of the one of plurality of intercom door-stations, determines if the one of the plurality of intercom door-stations can be connected with the intercom master-station according to the connectivity information stored in the connectivity information memory and the station information received from the intercom door-station, stores the second IP address in the buffer memory into the first destination address memory as the first destination address and sends a registration request to the one of the plurality of intercom door-stations, the registration request including a first IP address assigned to the intercom master-station;
wherein the one of the plurality of intercom door-stations comprises;
a second destination address memory that stores a second destination address, the first IP address being stored in the second destination address as the second destination address when the one of the plurality of intercom door-stations receives the registration request from the intercom master-station.

8. The communication system according to claim 6, wherein the intercom door-station further comprises;
a transmitter that broadcasts the second IP address on the IP network,
a detector that detects a response from the IP network in response to the broadcasted second IP address, and
a IP address memory that stores the second IP address, the second IP address being stored in the IP address memory if the detector does not detect the response within a predetermined time period.

9. The communication system according to claim 7, wherein the controller monitors a communication between the intercom door-station and an another intercom door-station connected to the IP network and discards the second IP address stored in the buffer memory when the controller detects a response signal from the another intercom door-station to the intercom door-station, the response signal being transmitted from the another intercom door-station to the intercom door-station in response to the second IP address sent from the intercom door-station to the another intercom door-station.

10. The communication system according to claim 6, wherein the intercom master-station communicates to the intercom door-station according to the first destination address and the intercom door-station communicates to the intercom master-station according to the second destination address.

11. The communication system according to claim 6, wherein the station information includes station identification information and station attribution information.

12. A communication system comprises an intercom master-station, a intercom door-station and a monitor camera connected to an IP network, a first IP address, a second IP address and a third IP address being assigned to the intercom master-station, the intercom door-station and the monitor camera respectively by using a DHCP protocol,
wherein the intercom master-station comprises;
a connectivity information memory that stores connectivity information on the intercom door-station and the monitor camera, the connectivity information indicating if each of the intercom door-station and the monitor camera can connect with the intercom master-station;
a buffer memory that stores at least one of the second IP address sent from the intercom door-station and the third IP address sent from the monitor camera;
a first destination address memory that stores a first destination address for the intercom door-station and a second destination address for the monitor camera,
a controller that sends a request to the intercom door-station and the monitor camera according to the second IP address and the third IP address stored in the buffer memory to obtain station information of the intercom door-station and the monitor camera, determines if the intercom door-station and the monitor camera can be connected with the intercom master-station according to the connectivity information stored in the connectivity information memory and the station information received from the intercom door-station and the monitor camera, stores the second IP address and the third IP address in the buffer memory into the first destination address memory as the first destination address and the second destination address, and sends a registration request to the intercom door-station and the monitor camera, the registration request including the first IP address;
wherein the intercom door-station comprises;
a second destination address memory that stores a third destination address, the first IP address being stored in the second destination address as the third destination address when the intercom door-station receives the registration request from the intercom master-station.
wherein the monitor camera comprises;
a third destination address memory that stores a fourth destination address, the first IP address being stored in the third destination address memory as the fourth destination address when the monitor camera receives the registration request from the intercom master-station.

13. The communication system according to claim 12,
wherein the intercom door-station further comprises;
a first transmitter that broadcasts the second IP address on the IP network,
a first detector that detects a response from the IP network in response to the broadcasted second IP address, and
a first IP address memory that stores the second IP address, the second IP address being stored in the first IP address memory if the first detector does not detect the response within a predetermined time.
wherein the monitor camera further comprises;
a second transmitter that broad casts the third IP address on the IP network,
a second detector that detects a response from the IP network in response to the broadcasted third IP address, and
a second IP address memory that stores the third IP address, the third IP address being stored in the second IP address memory if the second detector does not detect the response within the predetermined time.

14. The communication system according to claim 12, wherein the controller monitors a communication between the intercom door-station and an another intercom door-station connected to the IP network and discards the second IP address stored in the buffer memory when the controller detects a response signal from the another intercom door-station to the intercom door-station, the response signal being transmitted from the another intercom door-station to the intercom door-station in response to the second IP address sent from the intercom door-station to the another intercom door-station.

15. The communication system according to claim 12, wherein the intercom master-station communicates to the intercom door-station and the monitor camera according to the first and second destination addresses, the intercom door-station communicates to the intercom master-station according to the third destination address and the monitor camera communicates to the intercom master-station according to the fourth destination address.

16. The communication system according to claim 12, wherein the station information includes station identification information and station attribution information.

17. The communication system according to claim 12, wherein the intercom master-station further comprises a display to display the connectivity information.

18. A communication apparatus connected to a terminal apparatus via an IP network, a first IP address and a second IP address being assigned to the communication apparatus and the terminal apparatus respectively, the communication apparatus comprising:
a memory that stores connectivity information on the terminal apparatus, the connectivity information indicating if the terminal apparatus can connect with the communications apparatus and a destination address for the terminal apparatus;
a receiver that receives the second IP address sent from the terminal apparatus; and
a controller that sends a request to the terminal apparatus by using the second IP address to obtain a terminal information of the terminal apparatus, determines if the terminal apparatus can be connected with the communication apparatus according to the connectivity information and the terminal information, stores the second IP address into the memory as the destination address and sends a registration request to the terminal apparatus, the registration request including the first IP address.

19. The communication apparatus according to claim 18, further comprising a buffer memory that stores the second IP address received by the receiver, the controller storing the second IP address stored in the buffer memory into the memory when the controller determines that the terminal apparatus can be connected to the communication apparatus.

20. The communication apparatus according to claim 19, wherein the controller monitors a communication between the terminal apparatus and another terminal apparatus connected to the IP network and discards the second IP address stored in the buffer memory when the controller detects a response signal from the another terminal apparatus to the terminal apparatus, the response signal being transmitted from the another terminal apparatus to the terminal apparatus in response to the second IP address sent from the terminal apparatus to the another terminal apparatus.

21. The communication apparatus according to claim 20, wherein the terminal information includes terminal identification information and terminal attribution information.
